(19) United States
(12) Patent Application Publication
(10) Pub. No.: US 2016/0031099 A1
(43) Pub. Date: Feb. 4, 2016

(54) ELECTRIC SHAVER

(71) Applicant: Spectrum Brands, Inc., Middleton, WI (US)

(72) Inventors: Daniel John Provolo, Barrington, RI (US); Richard Kirk Maguire, Verona, WI (US); Daniel Richard Teteak, Madison, WI (US); Paul Anthony Schneider, Waunakee, WI (US); Wang Xuan, Hong Kong (CN); John Y.M. Wong, Hong Kong (CN)

(21) Appl. No.: 14/815,264

(22) Filed: Jul. 31, 2015

Related U.S. Application Data
(60) Provisional application No. 62/031,548, filed on Jul. 31, 2014.

(51) Int. Cl. B26B 19/10; B26B 19/38

(52) U.S. Cl. CPC B26B 19/10; B26B 19/3846

(57) ABSTRACT

An electric shaver generally includes a handle and a head mounted on the handle. The head has at least three cutter assemblies arranged in a forward-rearward direction. The cutter assemblies include a forwardmost cutter assembly and a rearwardmost cutter assembly that are long hair cutter assemblies. Each of the long hair cutter assemblies has a substantially U-shaped upper blade and a lower blade in shearing contact with the upper blade. The cutter assemblies further include a short hair cutter assembly disposed between the long hair cutter assemblies.

### CROSS-REFERENCE TO RELATED APPLICATIONS

This application claims priority to Provisional Patent Application Ser. No. 62/031,548, filed on Jul. 31, 2014, which is incorporated herein by reference in its entirety.

### BACKGROUND

The present invention relates generally to grooming devices and, more particularly, to an electric shaver.

Conventional electric shavers typically include a handle and a head attached to the handle. The head has a stationary blade and a movable blade that are arranged in sliding, face-to-face contact with one another. In operation, the movable blade is driven back and forth relative to the stationary blade as the head is moved over the skin in an area to be shaved. However, some conventional shavers have a less than desirable cutting effectiveness.

There is a need, therefore, for an electric shaver with improved cutting effectiveness.

### SUMMARY

In one embodiment, an electric shaver generally comprises a handle and a head mounted on the handle. The head includes at least three cutter assemblies arranged in a forward-rearward direction. The cutter assemblies include a forwardmost cutter assembly and a rearwardmost cutter assembly that are long hair cutter assemblies. Each of the long hair cutter assemblies has a substantially U-shaped upper blade and a lower blade in shearing contact with the upper blade. The cutter assemblies further comprise a short hair cutter assembly disposed between the long hair cutter assemblies.

In another embodiment, an upper blade for an electric shaver generally comprises a pair of sidewalls and a plurality of cutting members extending between the sidewalls such that the upper blade is substantially U-shaped. The cutting members are oriented obliquely relative to the sidewalls when the upper blade is viewed from a top plan viewpoint.

In yet another embodiment, a lower blade for an electric shaver generally comprises a pair of sidewalls and a plurality of cutting members extending between the sidewalls such that the lower blade is substantially U-shaped. The cutting members are oriented obliquely relative to the sidewalls when the lower blade is viewed from a top plan viewpoint.

### BRIEF DESCRIPTION

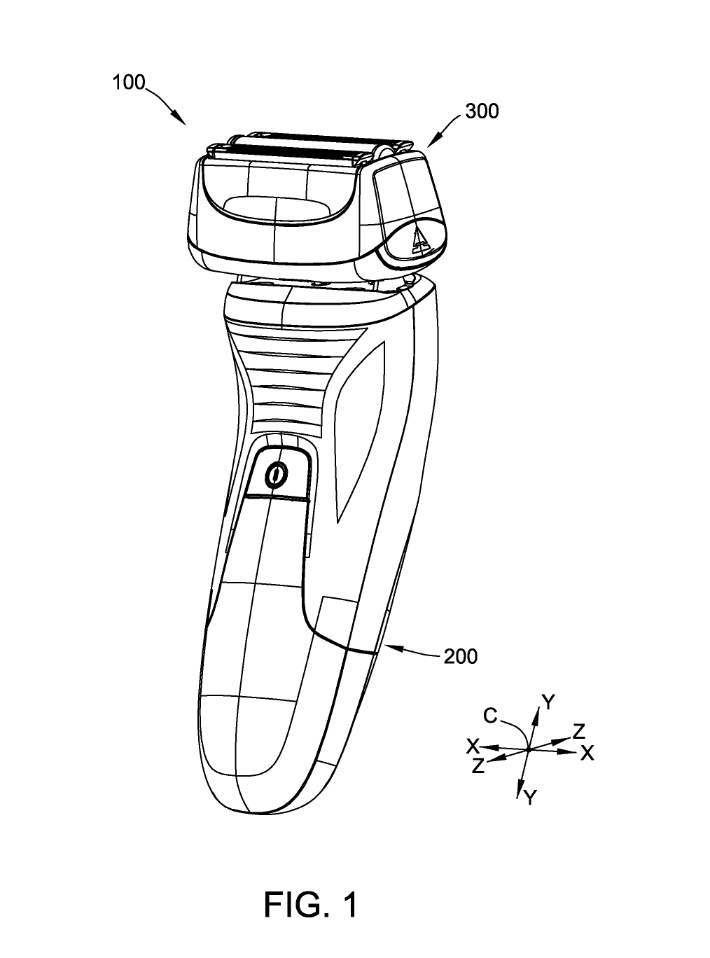

FIG. 1 is a perspective view of one embodiment of an electric shaver;

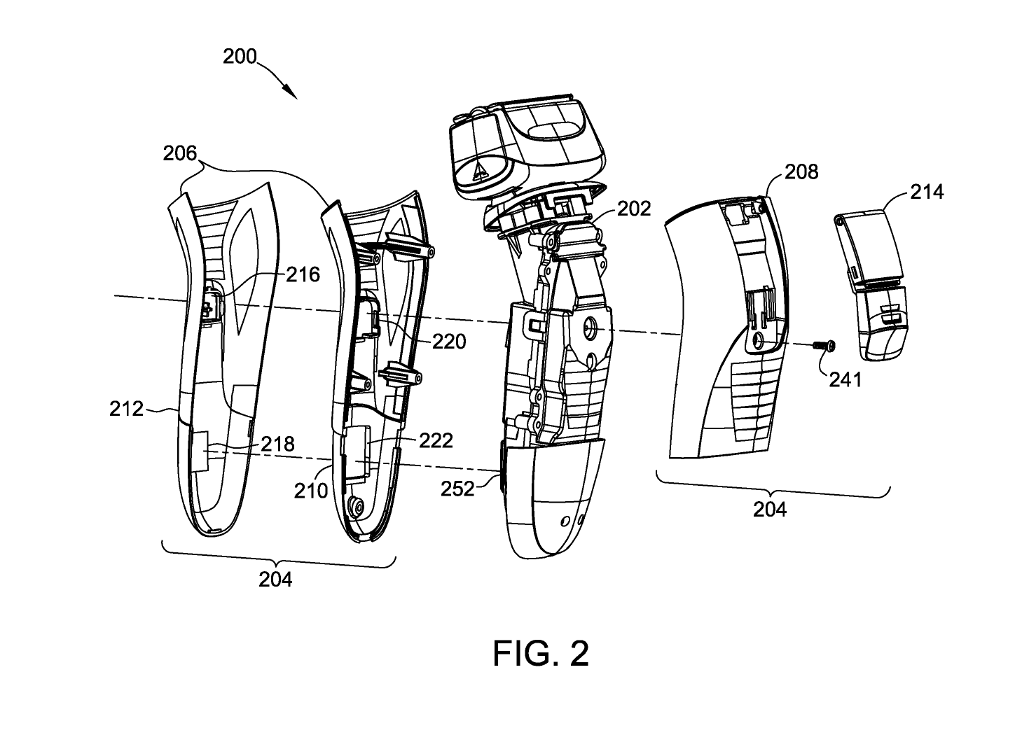

FIG. 2 is an exploded view of a handle of the shaver of FIG. 1;

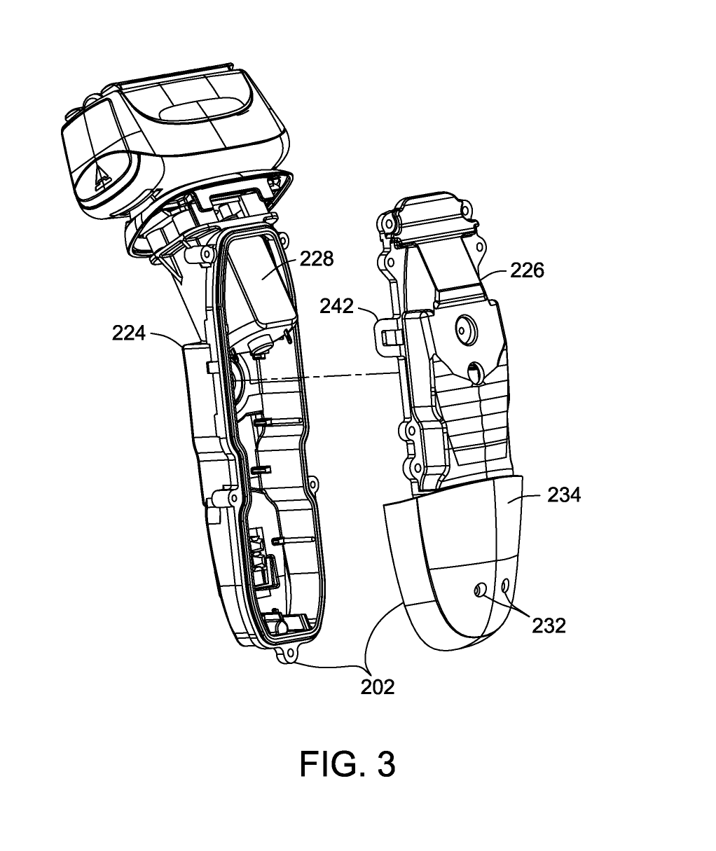

FIG. 3 is an exploded view of a core of the handle of FIG. 2;

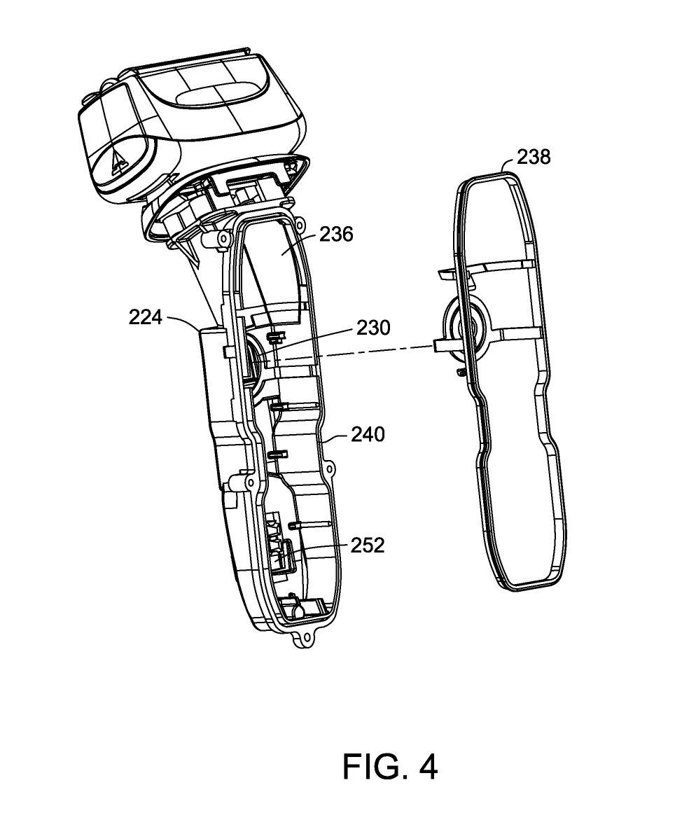

FIG. 4 is another exploded view of the core of FIG. 3;

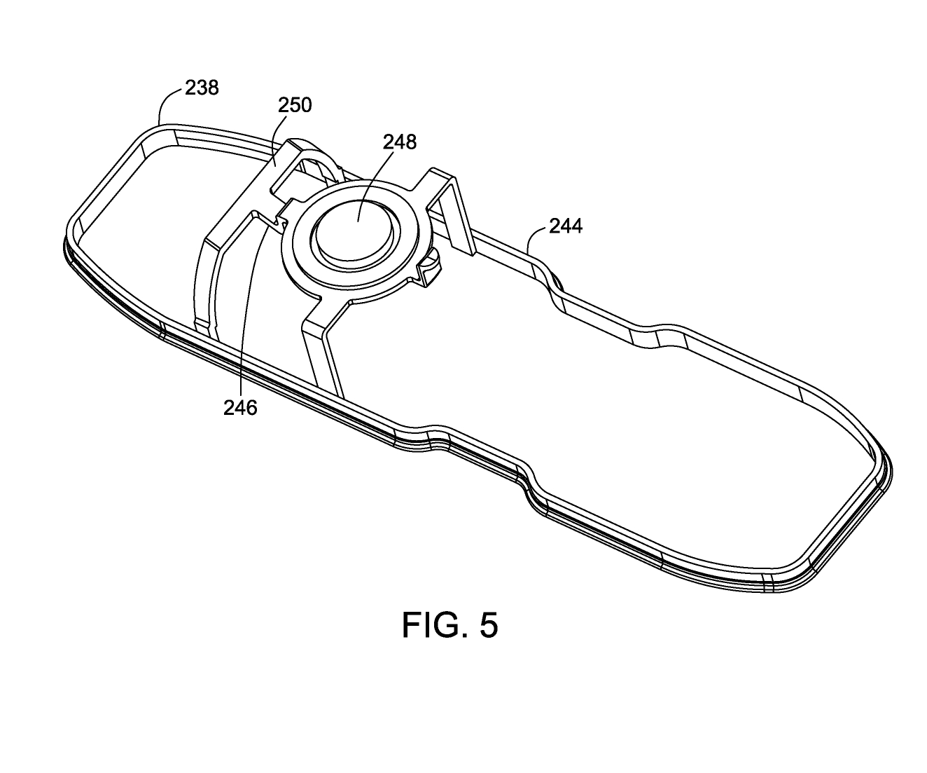

FIG. 5 is perspective view of a gasket of the core of FIG. 3;

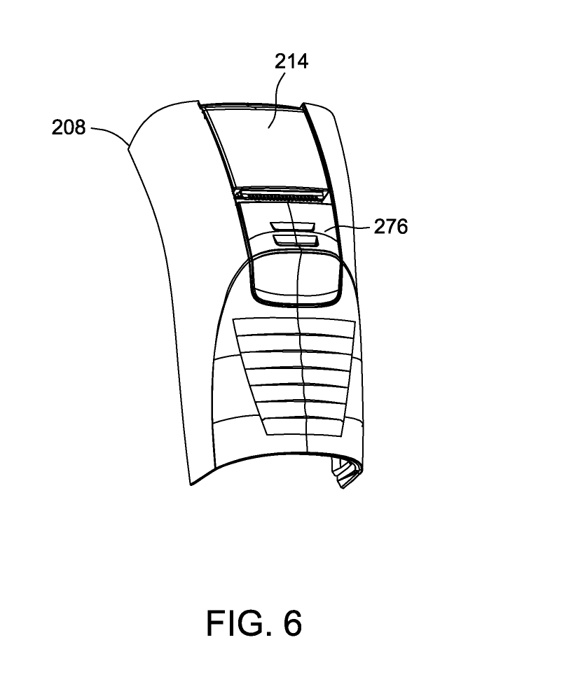

FIG. 6 is a perspective view of a back panel assembly of the handle of FIG. 2;

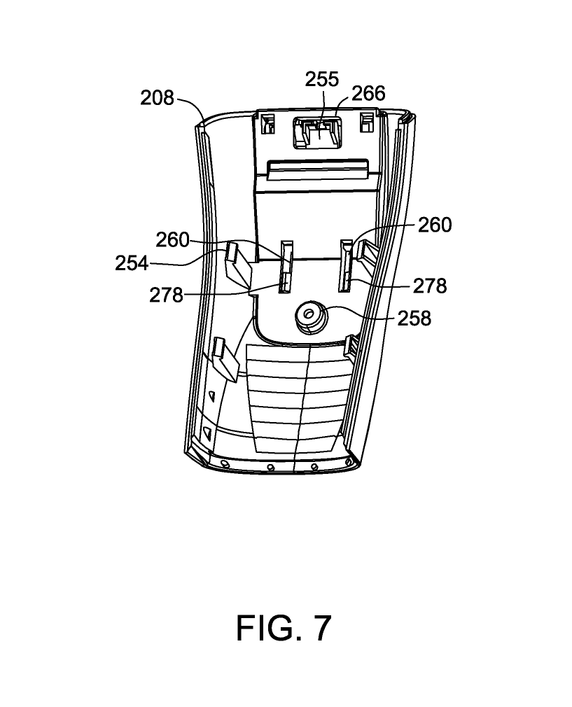

FIG. 7 is another perspective view of the back panel assembly of FIG. 6;

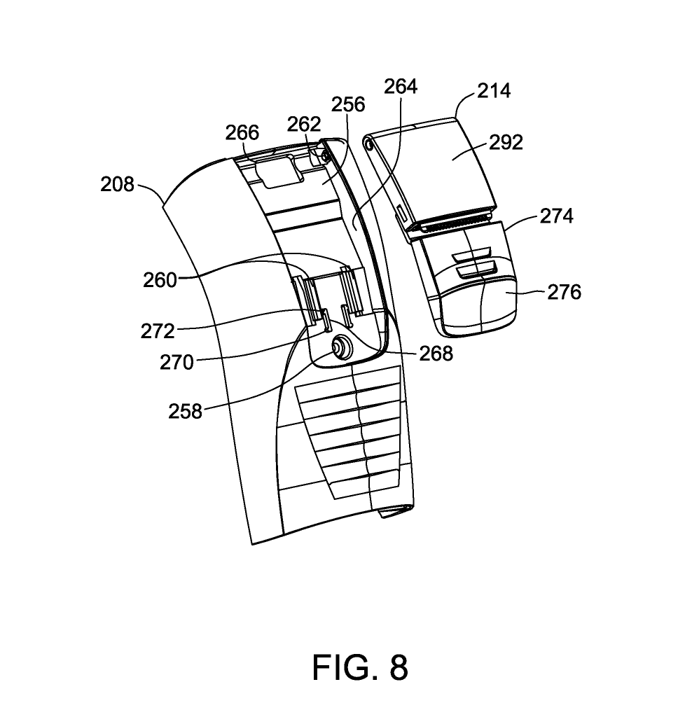

FIG. 8 is an exploded view of the back panel assembly of FIG. 6;

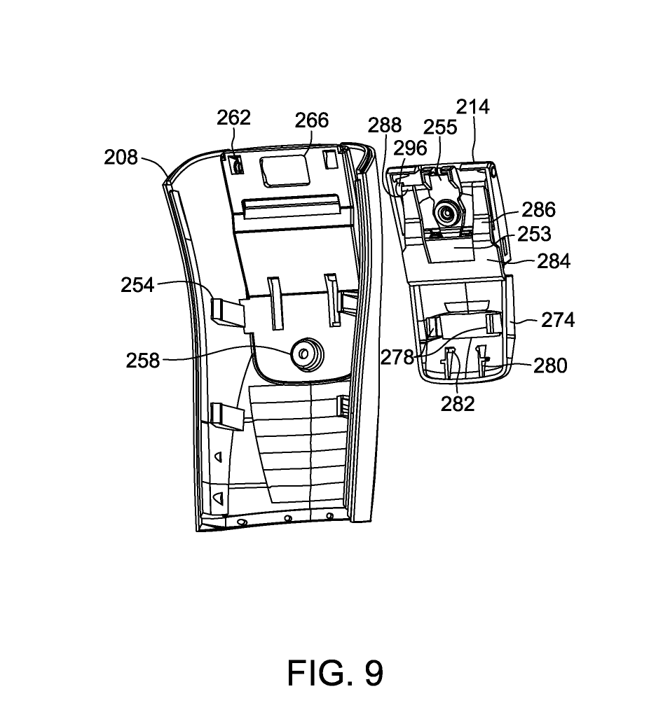

FIG. 9 is another exploded view of the back panel assembly of FIG. 6;

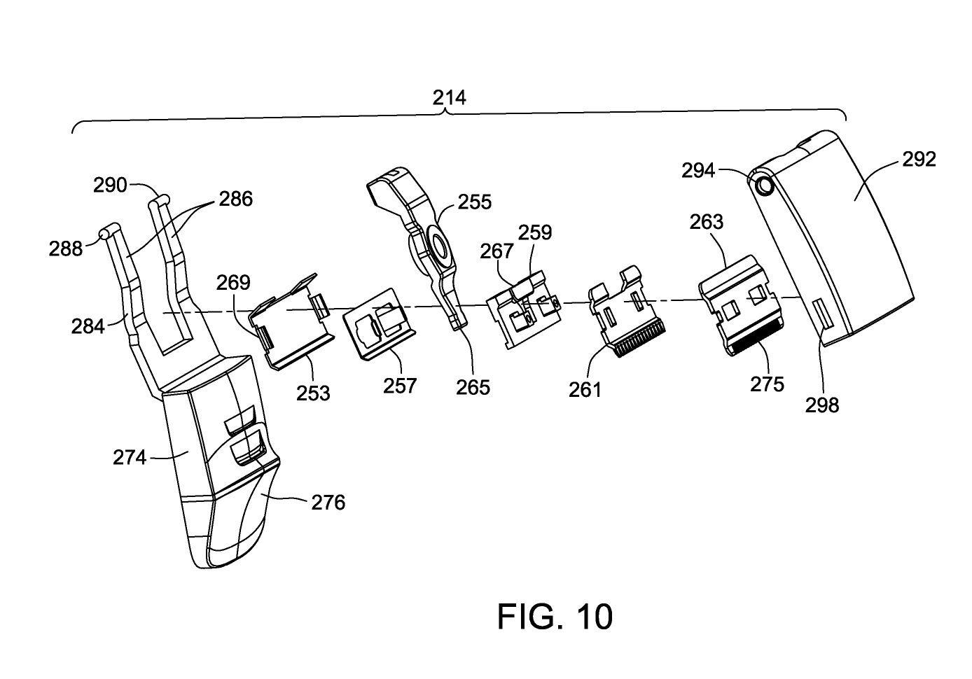

FIG. 10 is an exploded view of a trimmer of the back panel assembly of FIG. 6;

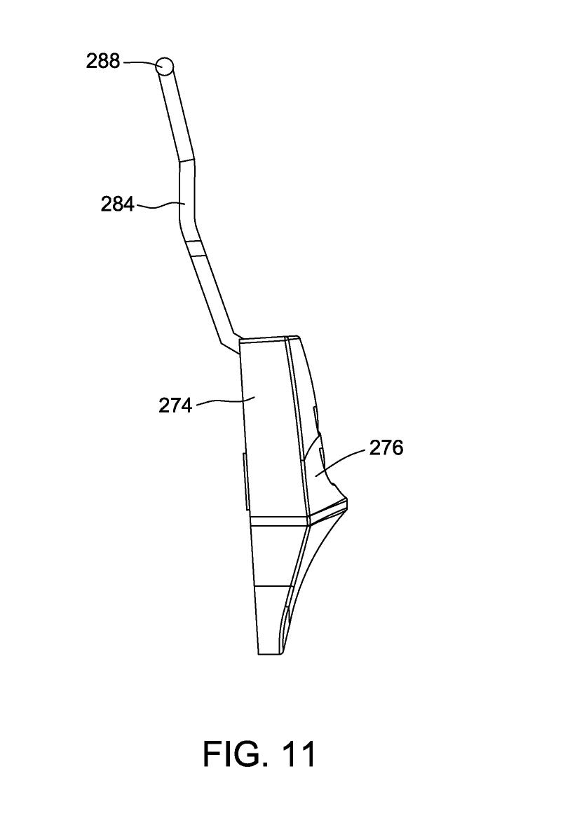

FIG. 11 is a side elevation of a slide of the trimmer of FIG. 10;

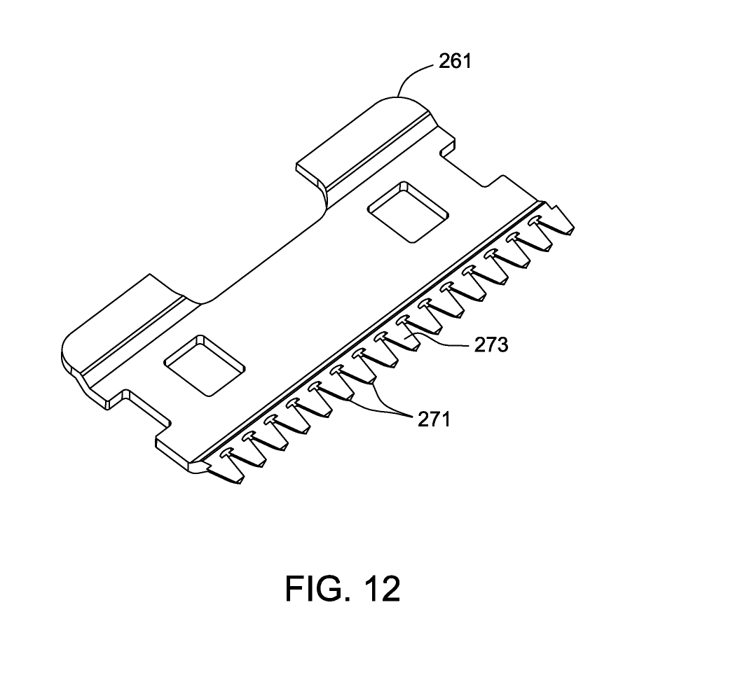

FIG. 12 is a perspective view of a movable blade of the trimmer of FIG. 10;

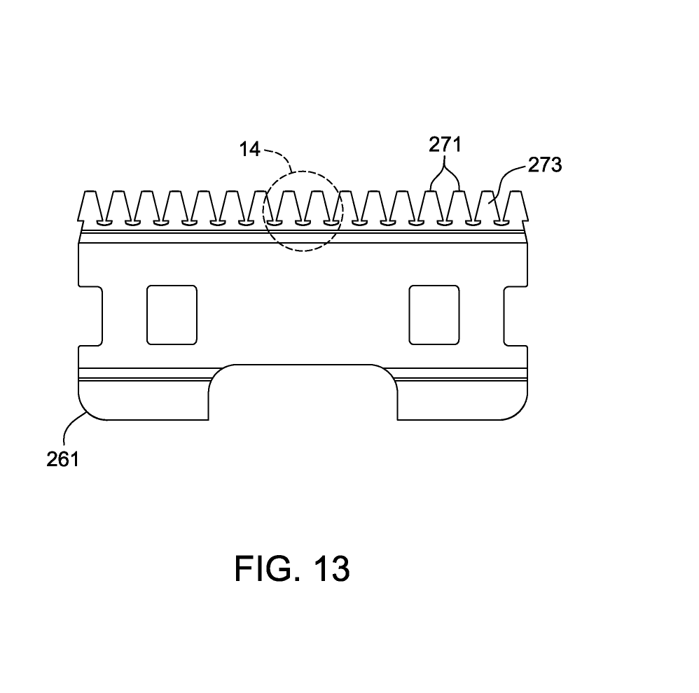

FIG. 13 is a top plan view of the movable blade of FIG. 12;

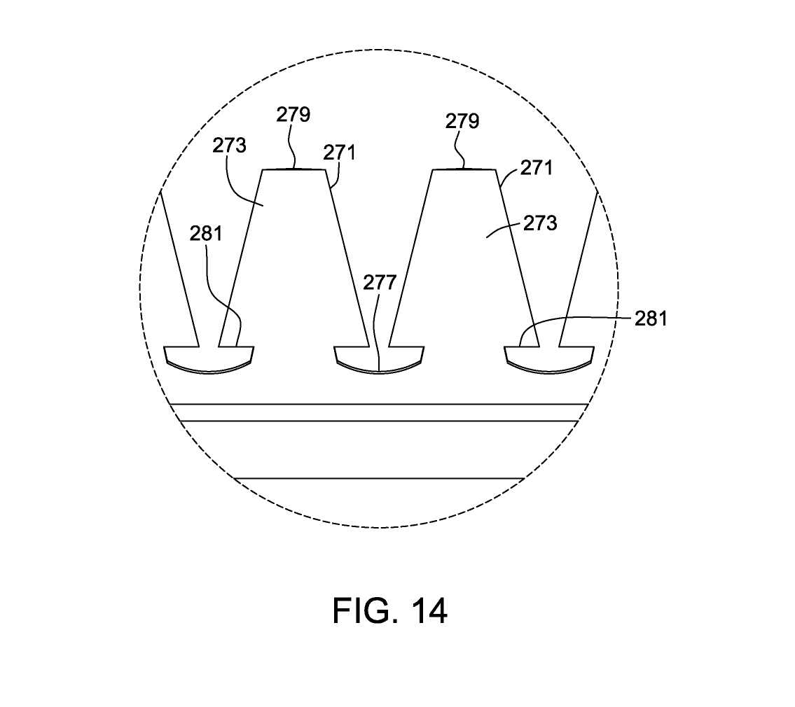

FIG. 14 an enlarged portion of the top plan view of FIG. 13 taken within area 14;

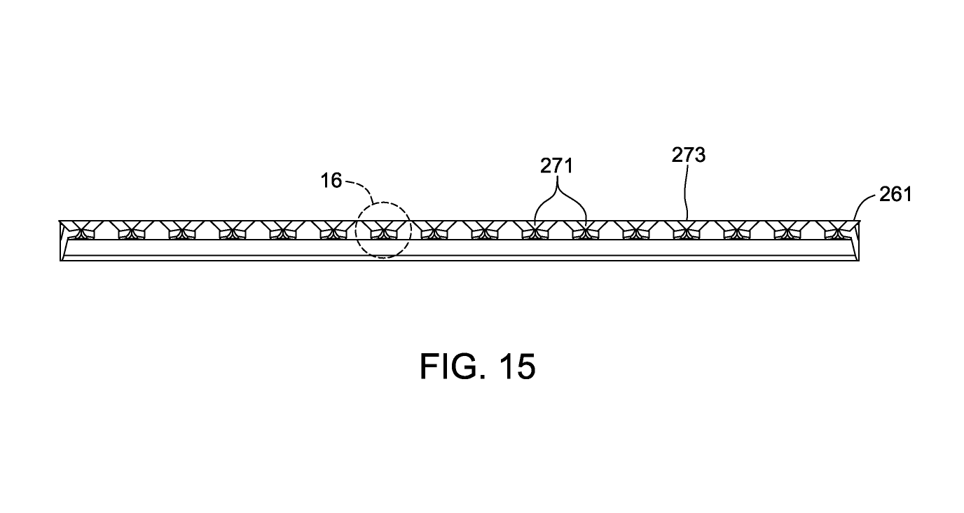

FIG. 15 is another plan view of the movable blade of FIG. 12;

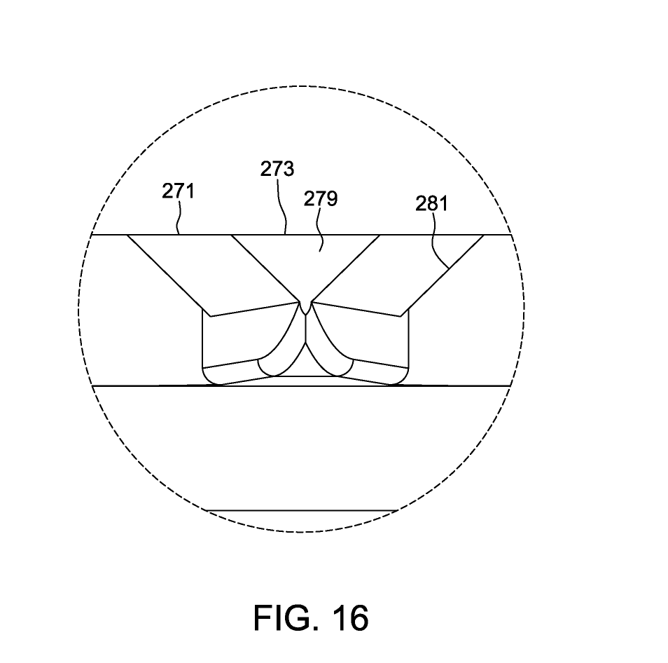

FIG. 16 an enlarged portion of the plan view of FIG. 15 taken within area 16;

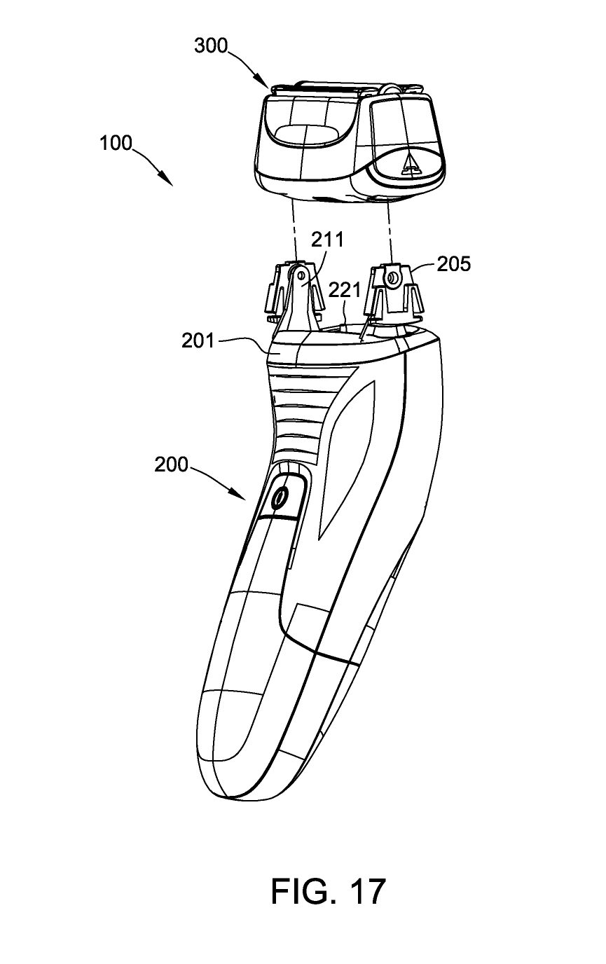

FIG. 17 is a view of the shaver of FIG. 1 with the shaver head separated from the shaver handle;

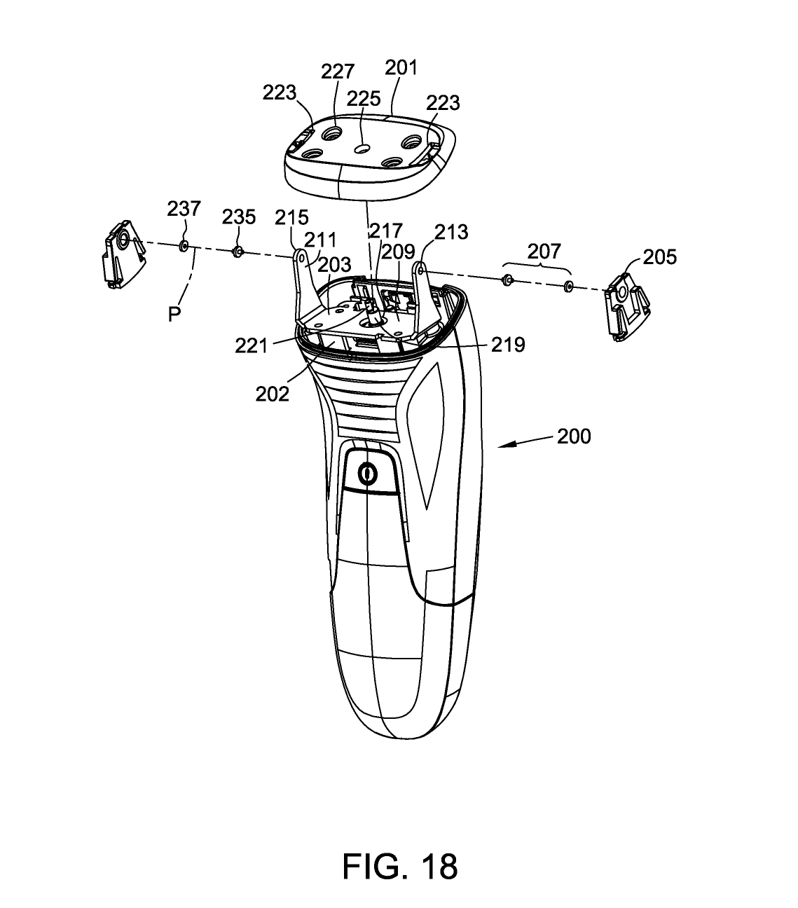

FIG. 18 is an exploded view of a yoke assembly of the shaver handle of FIG. 17;

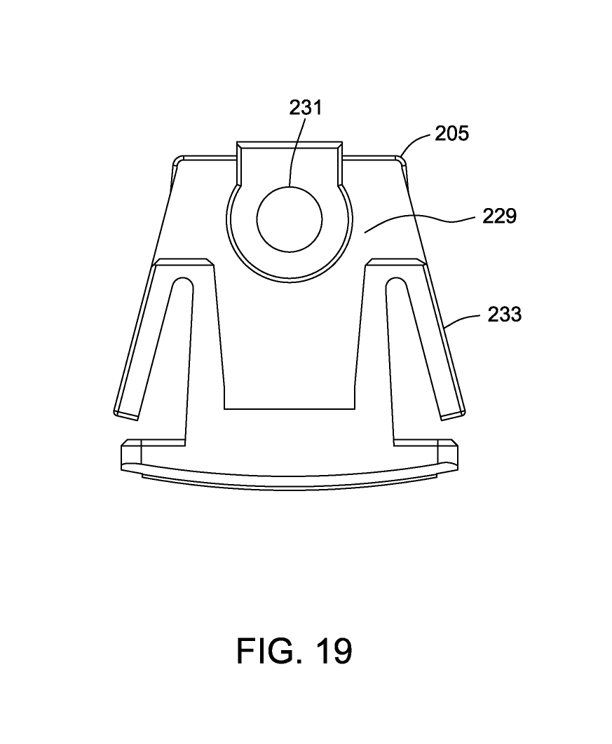

FIG. 19 is a clip of the yoke assembly of FIG. 18;

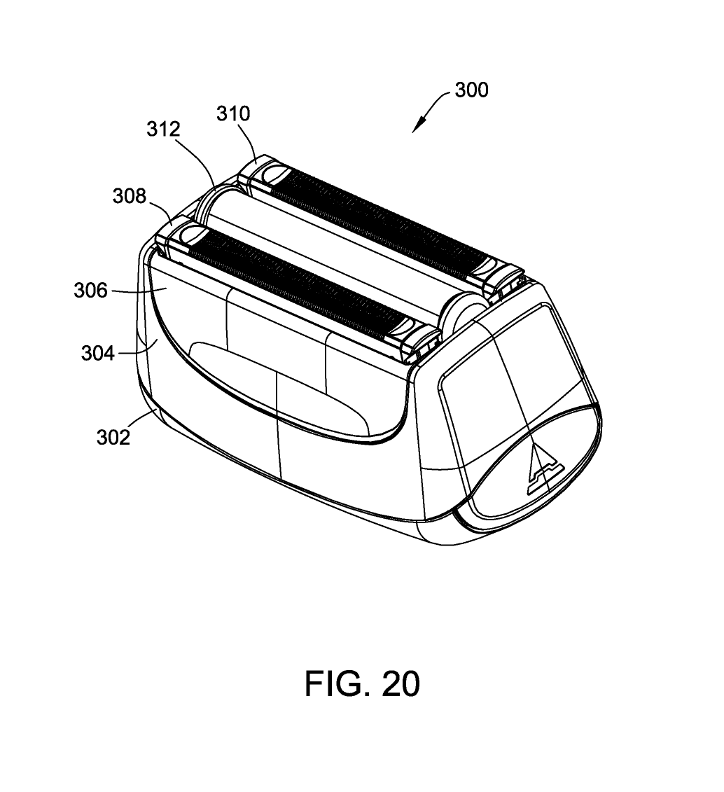

FIG. 20 is a perspective view of a head of the shaver of FIG. 1;

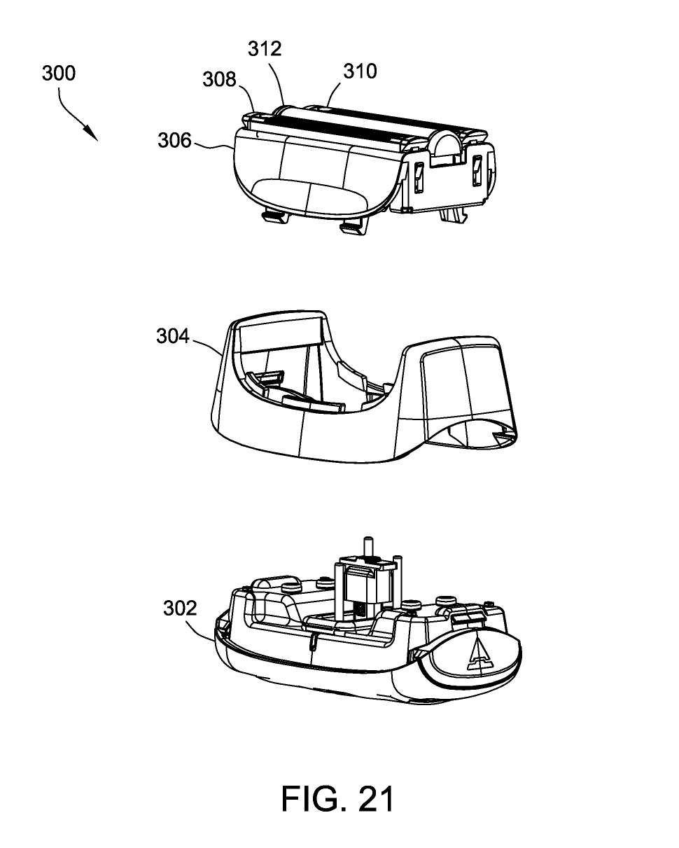

FIG. 21 is an exploded view of the head of FIG. 20;

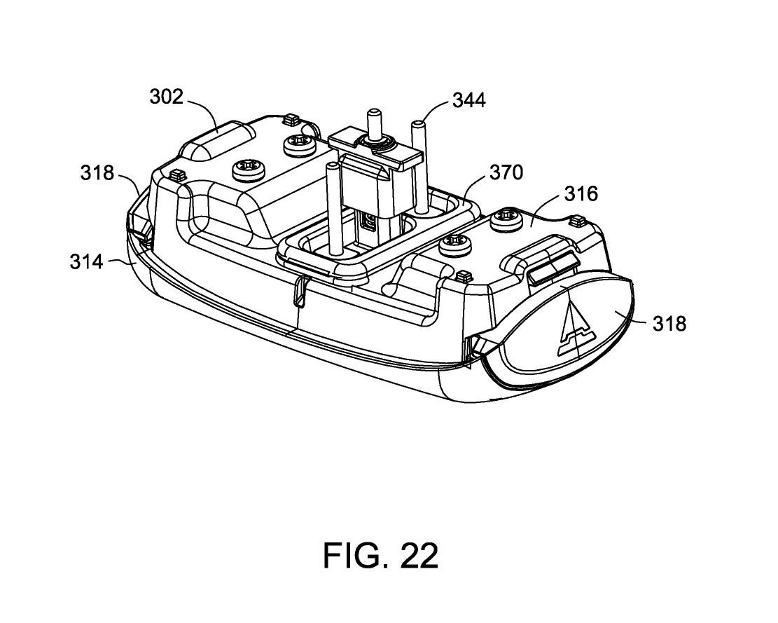

FIG. 22 is a perspective view of a base of the head of FIG. 20;

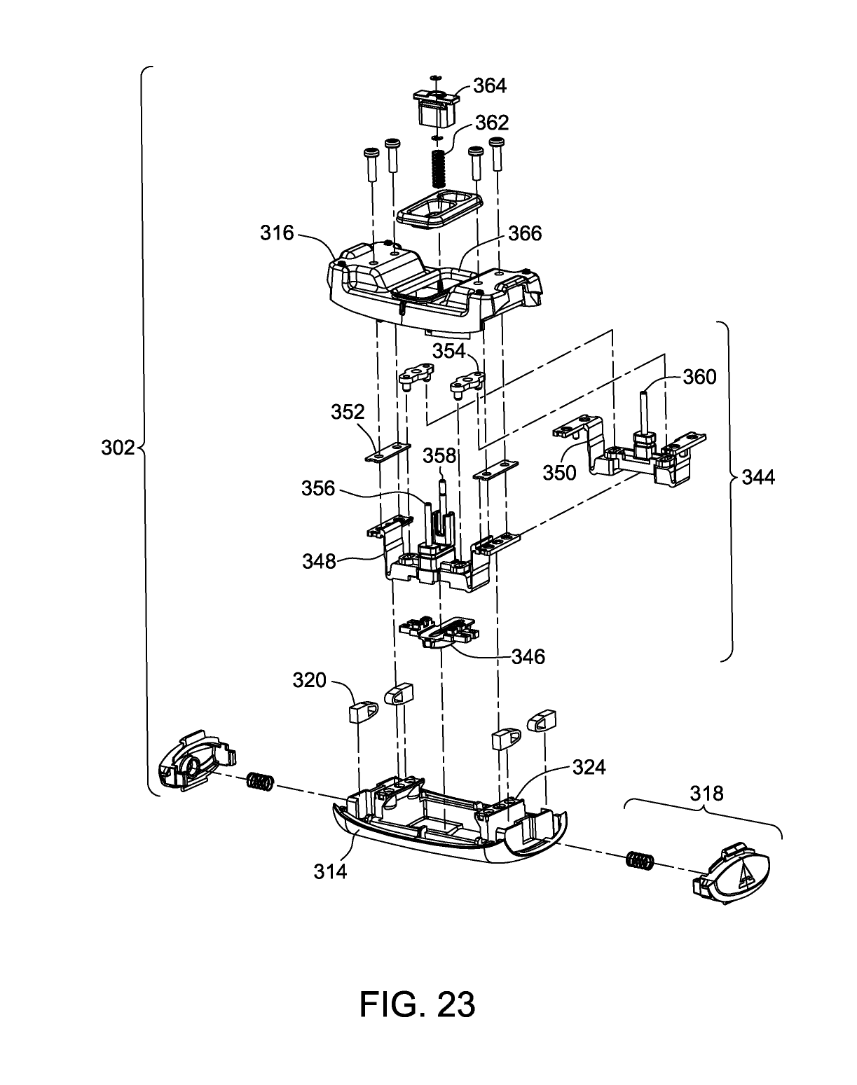

FIG. 23 is an exploded view of the base of FIG. 22;

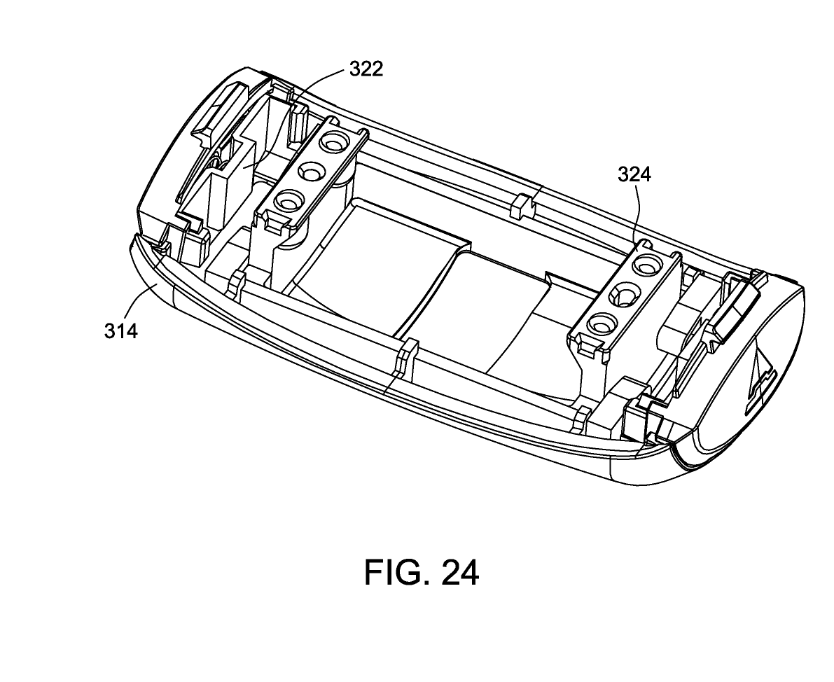

FIG. 24 is a perspective view of a bottom frame assembly of the base of FIG. 22;

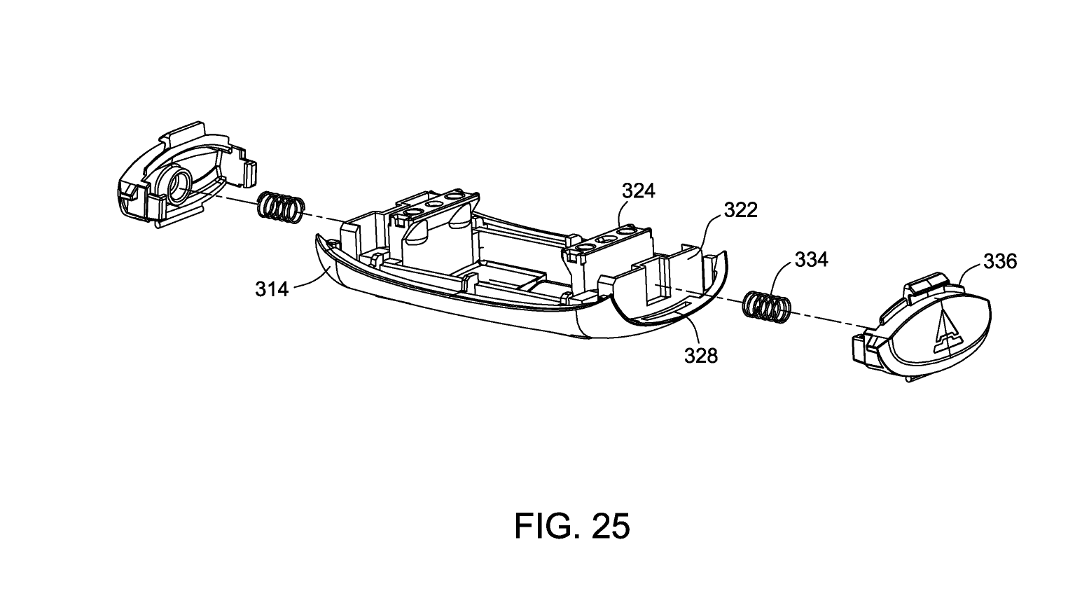

FIG. 25 is an exploded view of the bottom frame assembly of FIG. 24;

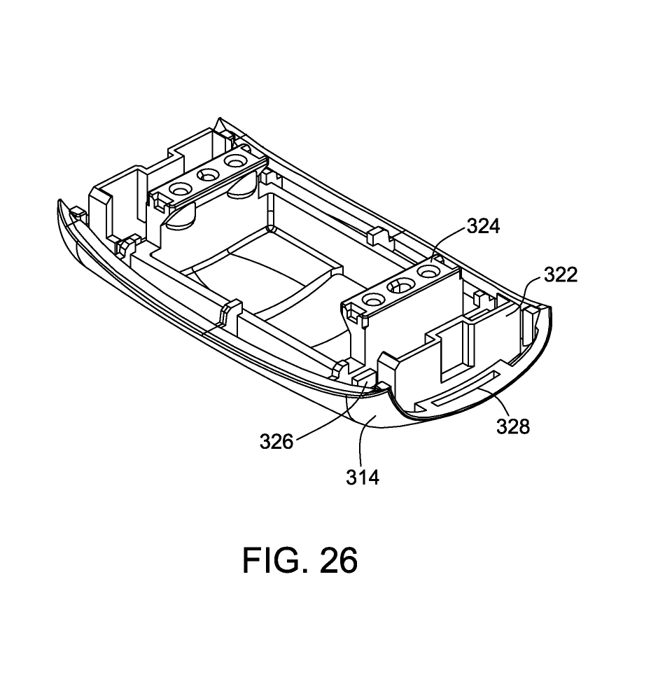

FIG. 26 is a perspective view of a bottom frame of the assembly of FIG. 24;

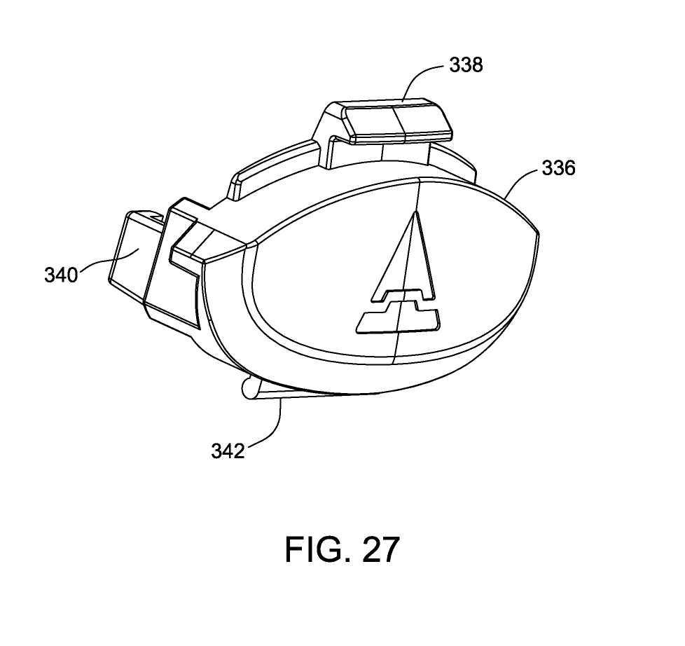

FIG. 27 is a perspective view of a button of the bottom frame assembly of FIG. 24;

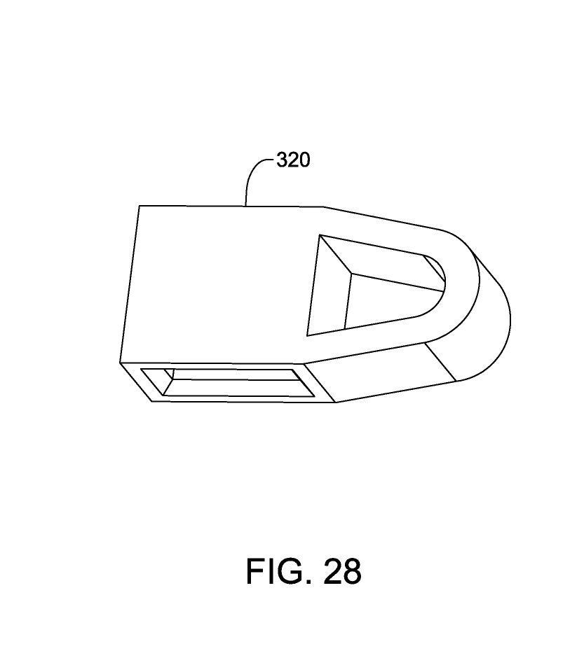

FIG. 28 is a perspective view of a biasing member of the bottom frame assembly of FIG. 24;

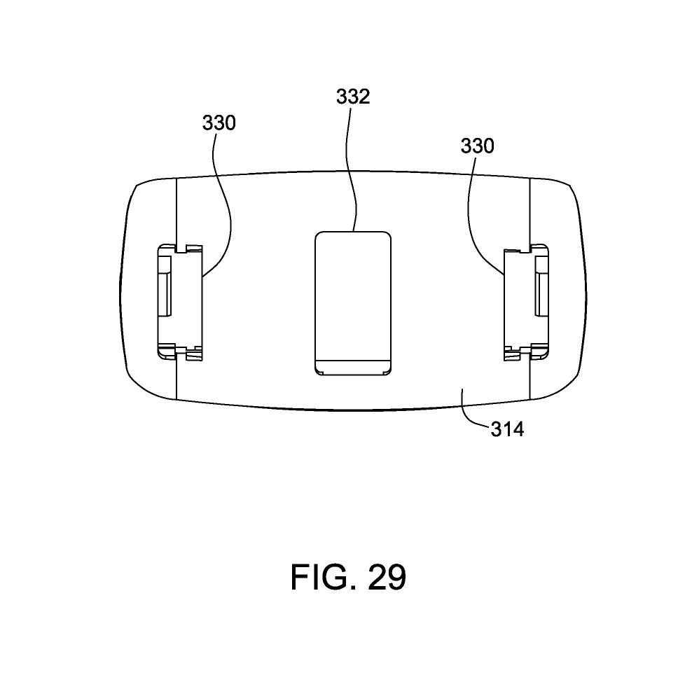

FIG. 29 is a bottom elevation view of the bottom frame assembly of FIG. 24;

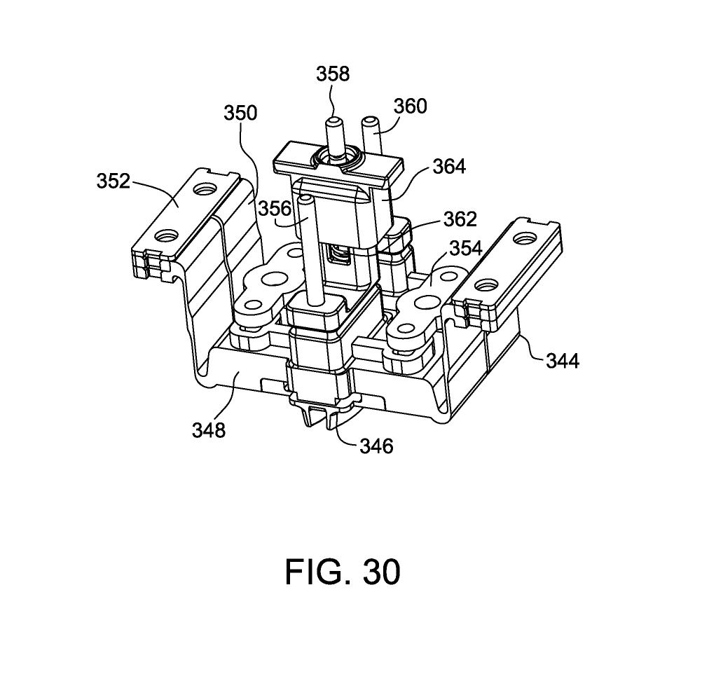

FIG. 30 is a perspective view of an oscillator assembly of the base of FIG. 22;

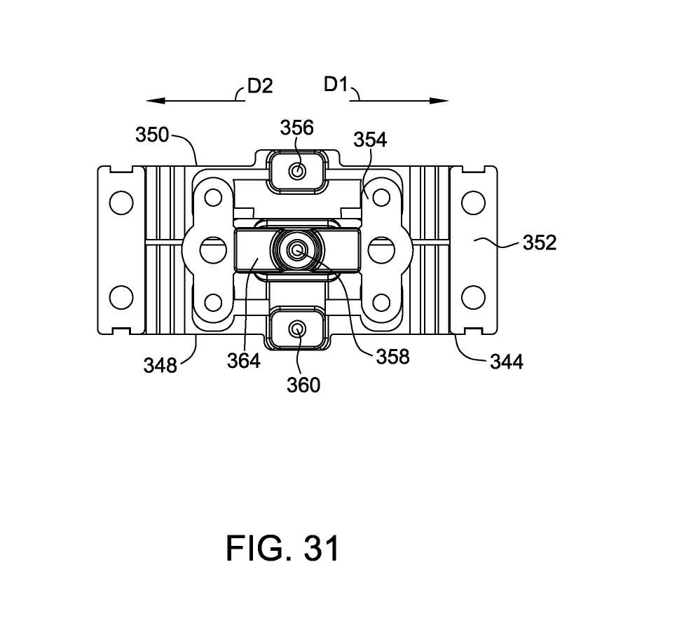

FIG. 31 is a top elevation view of the oscillator assembly of FIG. 30;

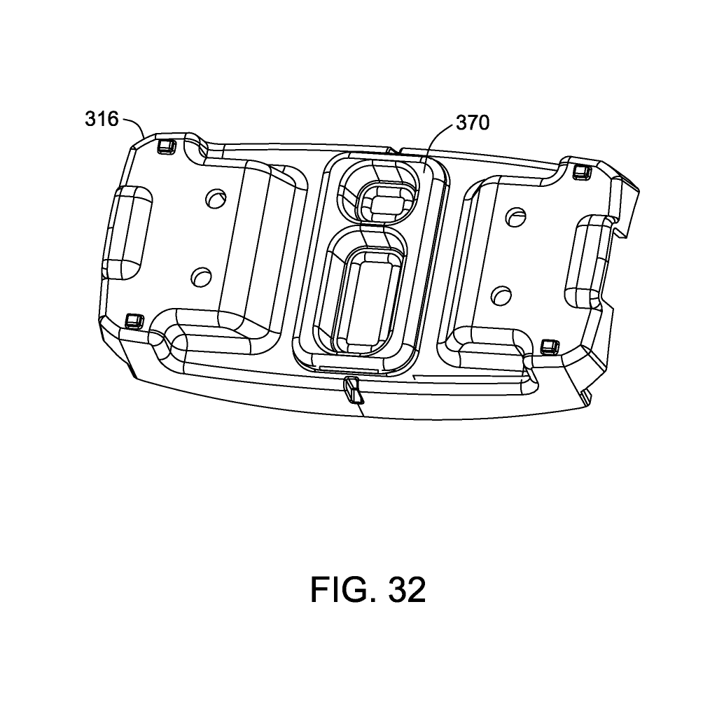

FIG. 32 is a perspective view of a top frame of the base of FIG. 22;

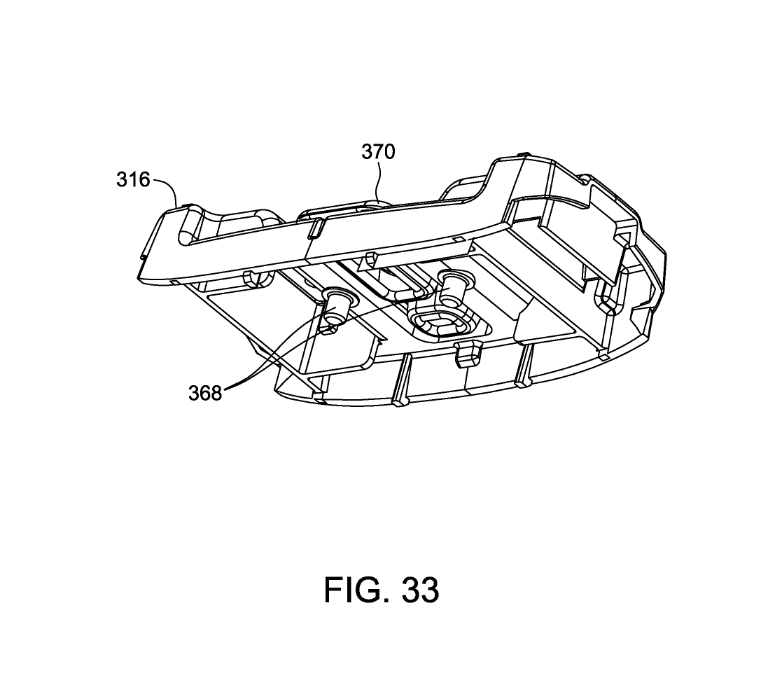

FIG. 33 is another perspective view of the top frame of FIG. 32;

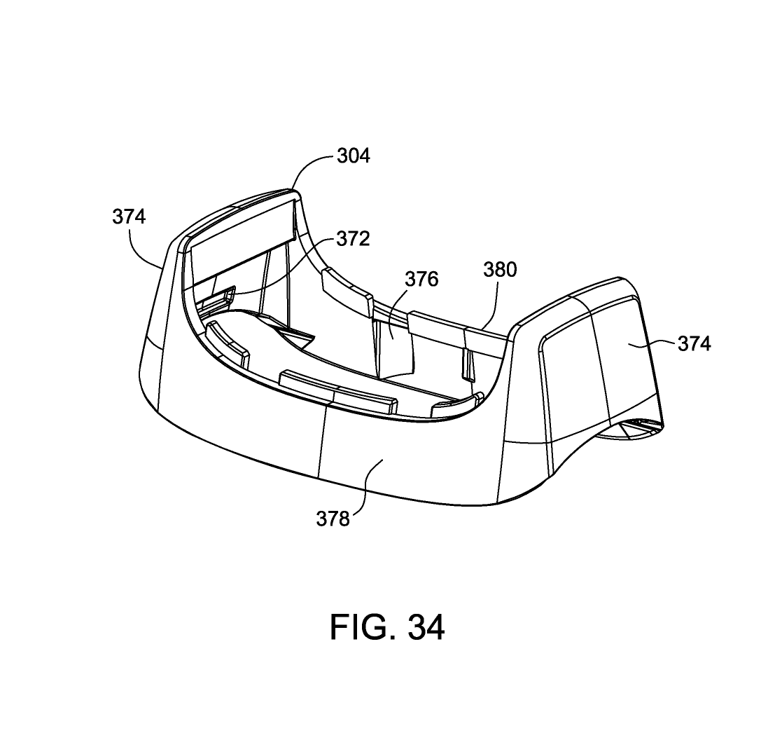

FIG. 34 is a perspective view of a housing of the head of FIG. 20;

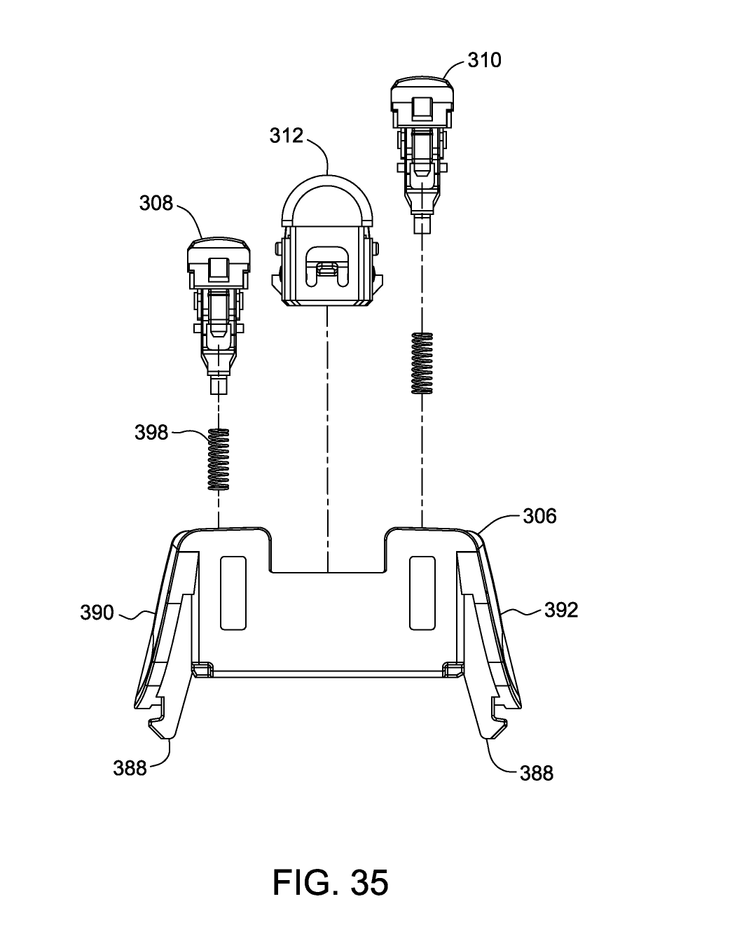

FIG. 35 is an exploded view of a chassis and cutter assembly of the head of FIG. 20;

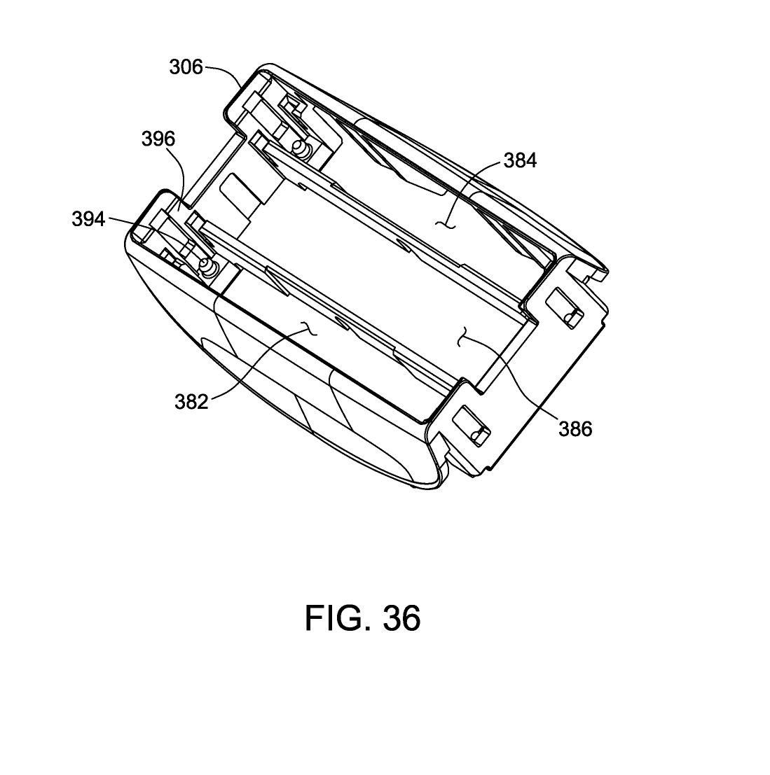

FIG. 36 is a perspective view of the chassis of the assembly of FIG. 35;

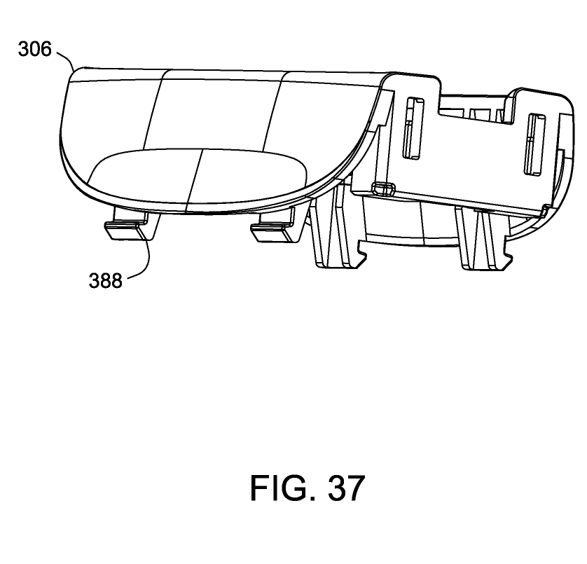

FIG. 37 is another perspective view of the chassis of FIG. 35;

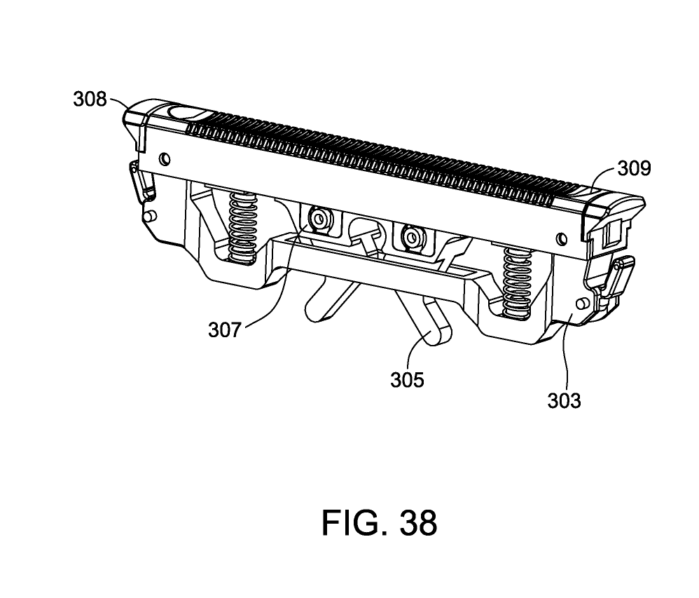

FIG. 38 is a perspective view of a long hair cutter assembly of the head of FIG. 20;

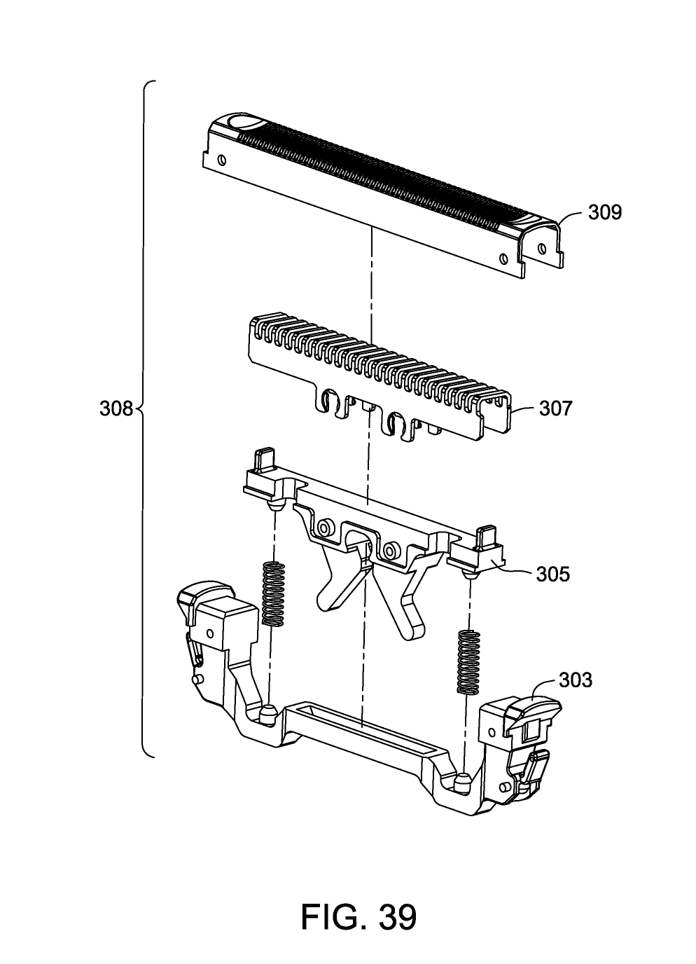

FIG. 39 is an exploded view of the long hair cutter assembly of FIG. 38;

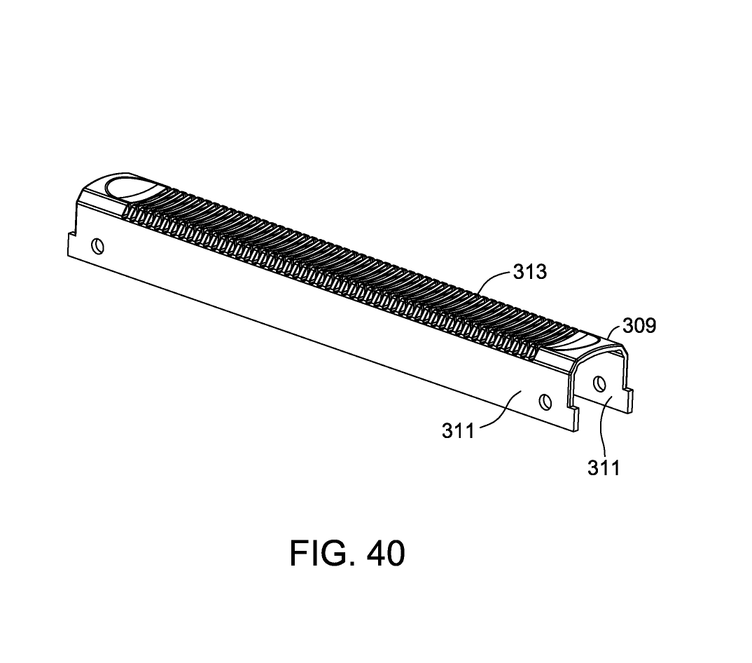

FIG. 40 is a perspective view of a stationary blade of the long hair cutter assembly of FIG. 38;

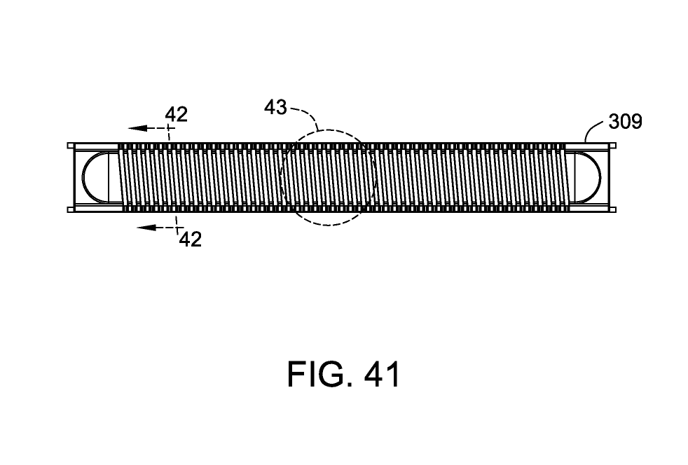

FIG. 41 is a top plan view of the stationary blade of FIG. 40;

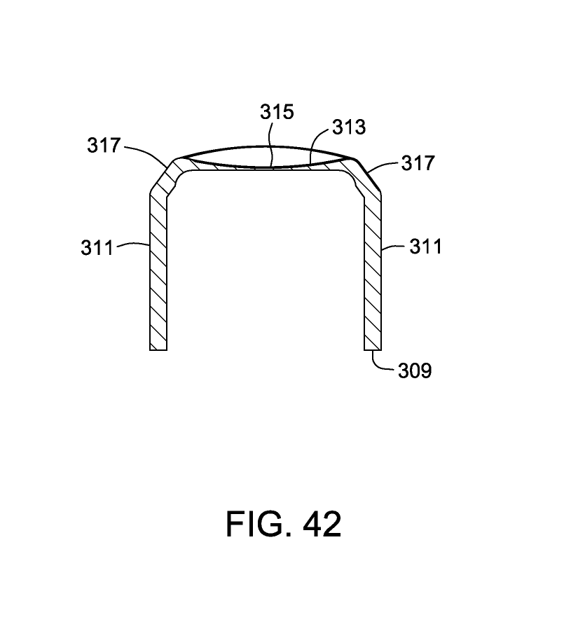

FIG. 42 is a cross-sectional view of the stationary blade of FIG. 40 taken along plane 42-42 of FIG. 41;

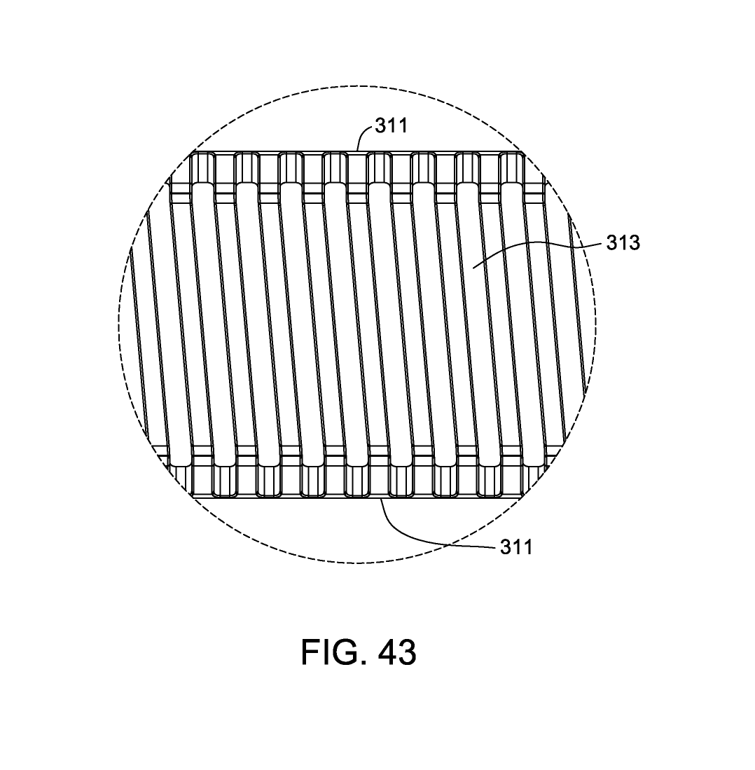

FIG. 43 is an enlarged portion of the top plan view of FIG. 41 taken within area 43;

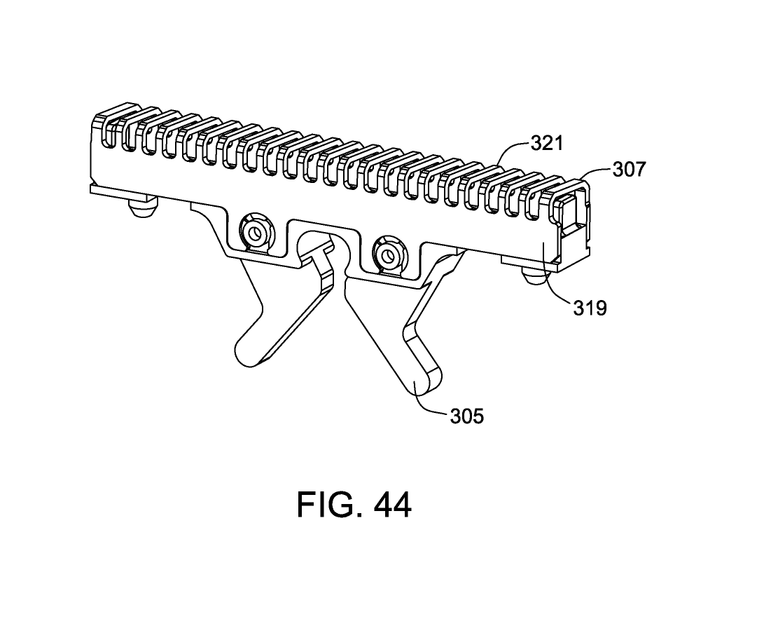

FIG. 44 is a perspective view of a movable blade assembly of the long hair cutter assembly of FIG. 38;

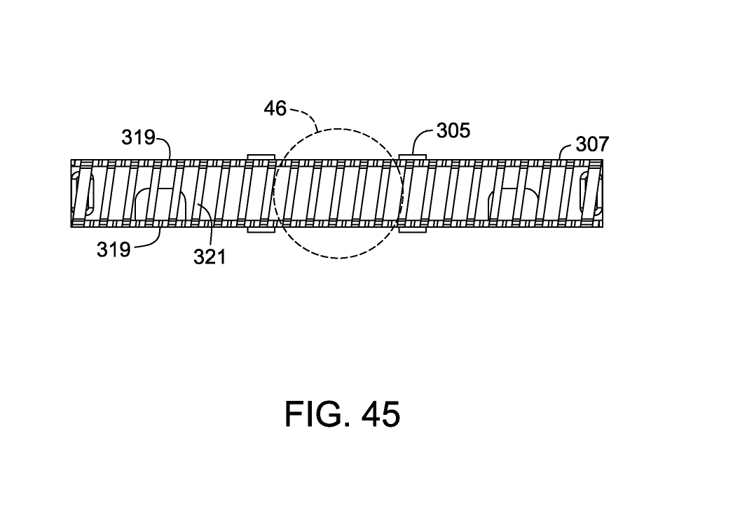

FIG. 45 is a top plan view of the movable blade assembly of FIG. 44;

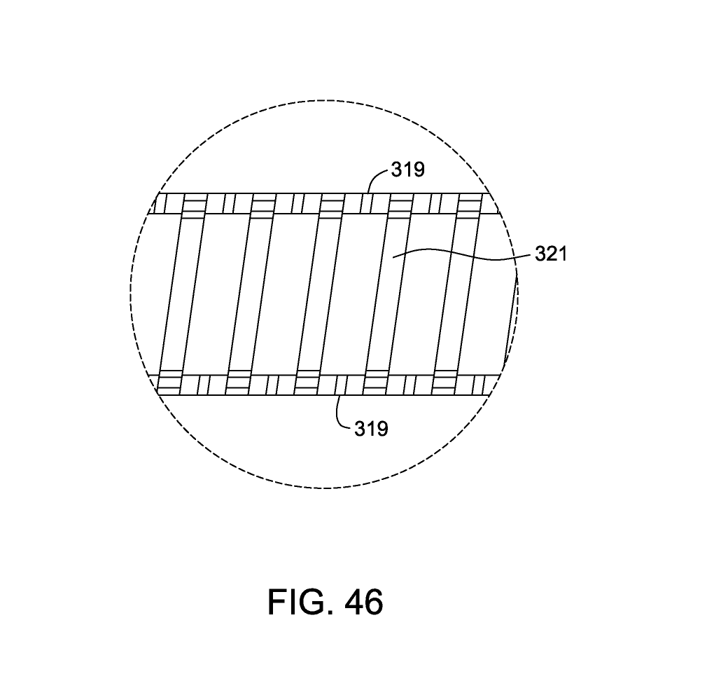

FIG. 46 is an enlarged portion of the top plan view of FIG. 45 taken within area 46;

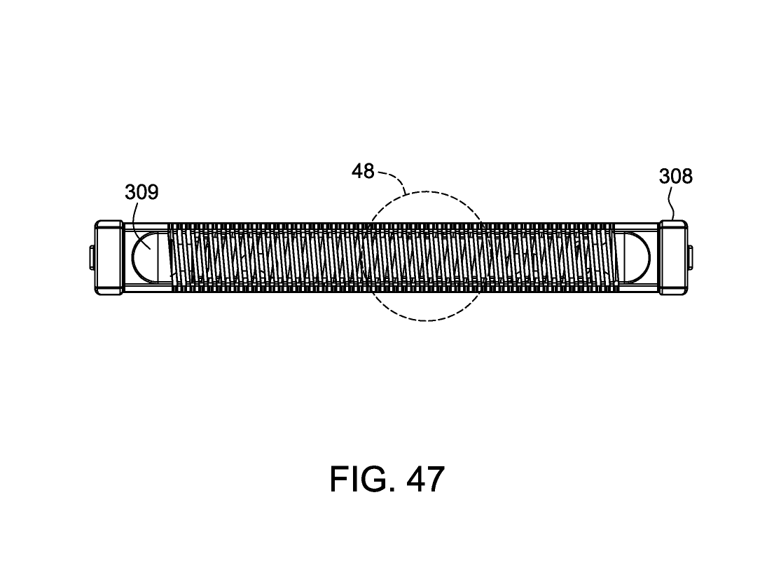

FIG. 47 is a top plan view of the long hair cutter assembly of FIG. 38;

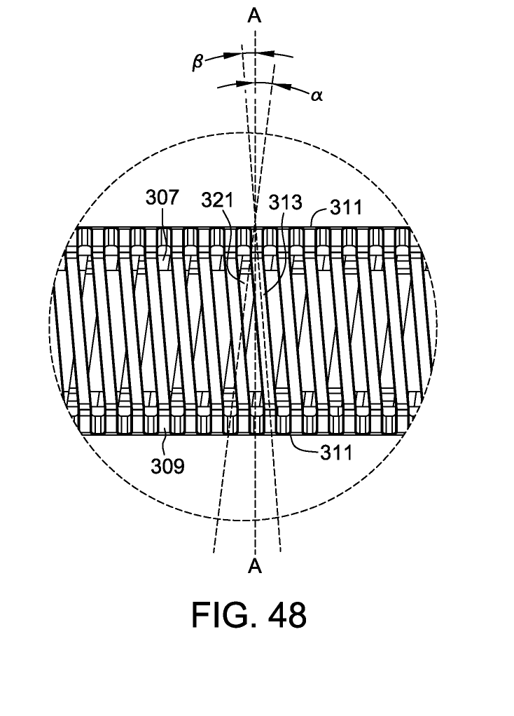

FIG. 48 is an enlarged portion of the top plan view of FIG. 47 taken within area 48;

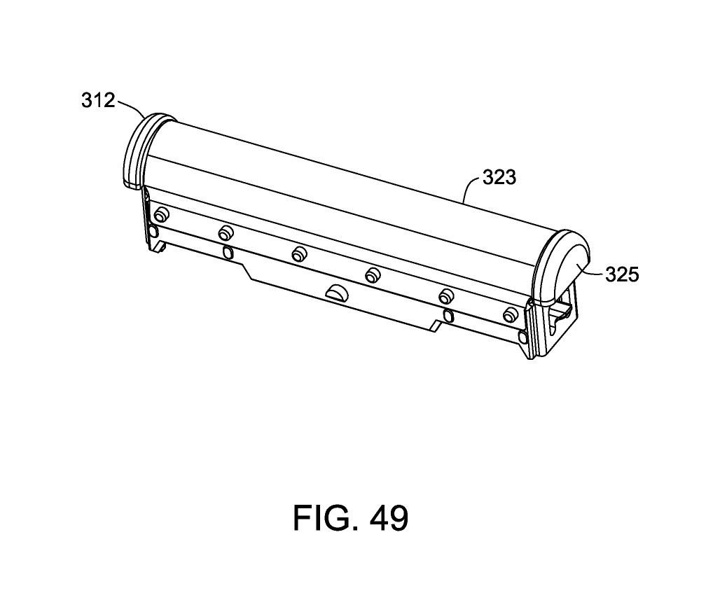

FIG. 49 is a perspective view of a short hair cutter assembly of the shaver head of FIG. 20;

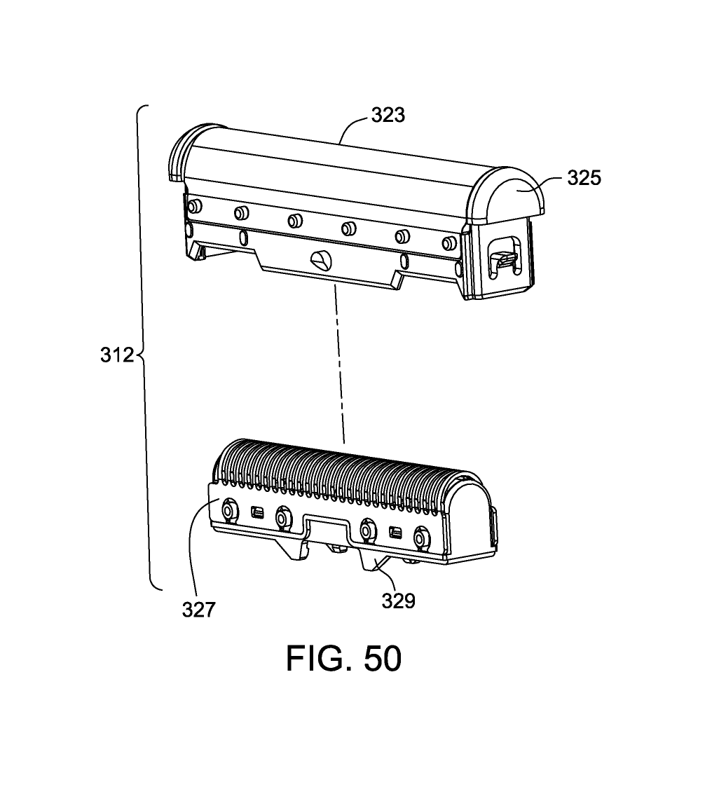

FIG. 50 is an exploded view of the short hair cutter assembly of FIG. 49;

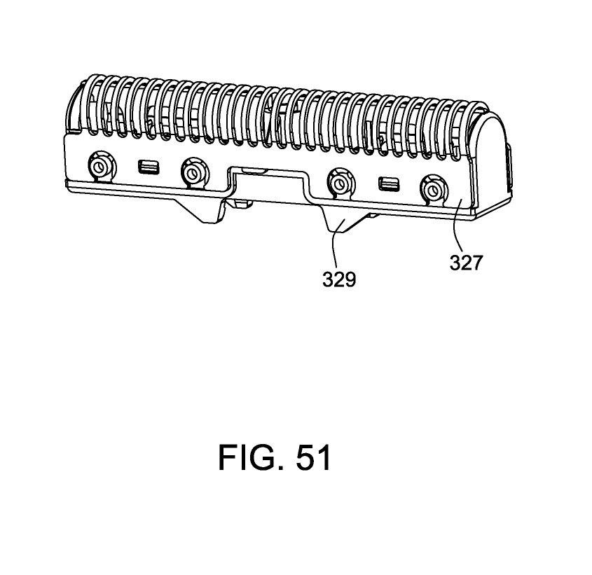

FIG. 51 is a movable blade assembly of the short hair cutter assembly of FIG. 49;

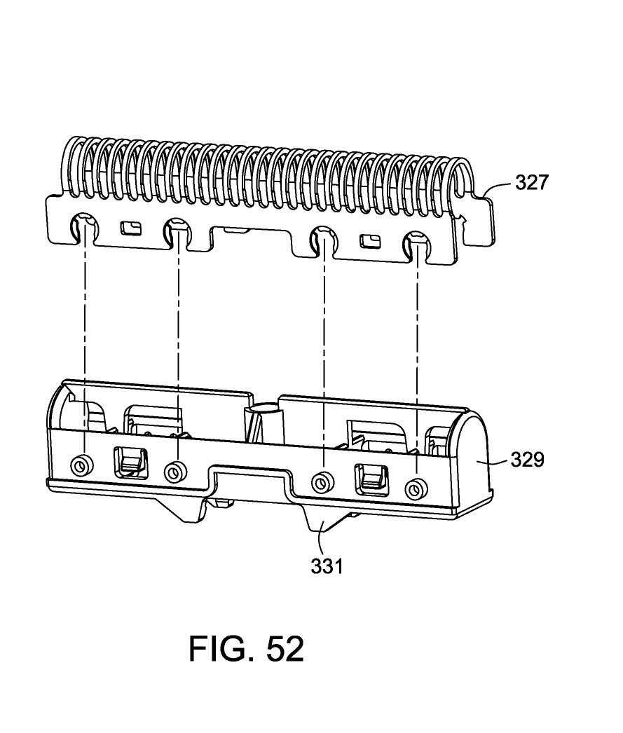

FIG. 52 is an exploded view of the movable blade assembly of FIG. 51;

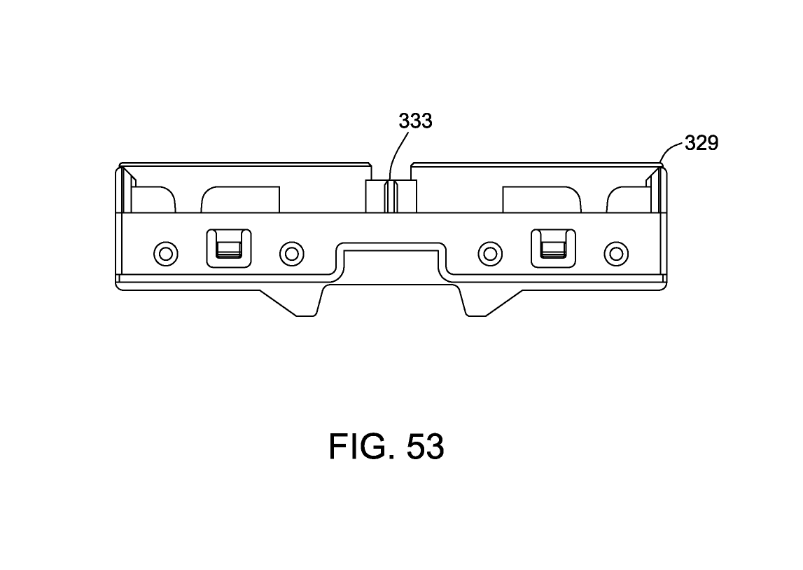

FIG. 53 is a side elevation of a carrier of the movable blade assembly of FIG. 51;

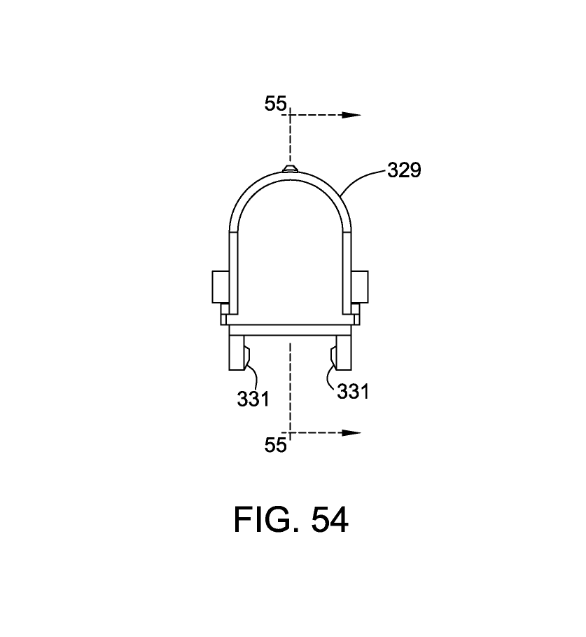

FIG. 54 is another side elevation of the carrier of FIG. 53;

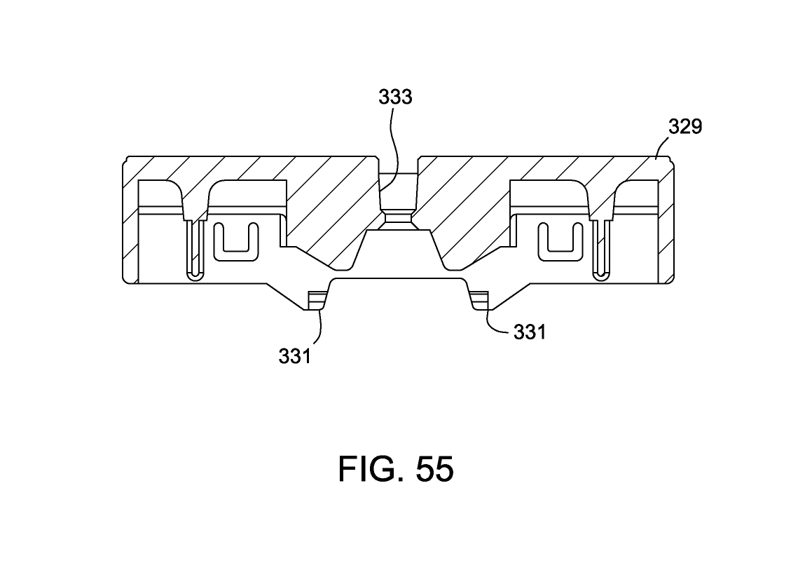

FIG. 55 is a cross-sectional view of the carrier of FIG. 53 taken along plane 55-55 of FIG. 54;

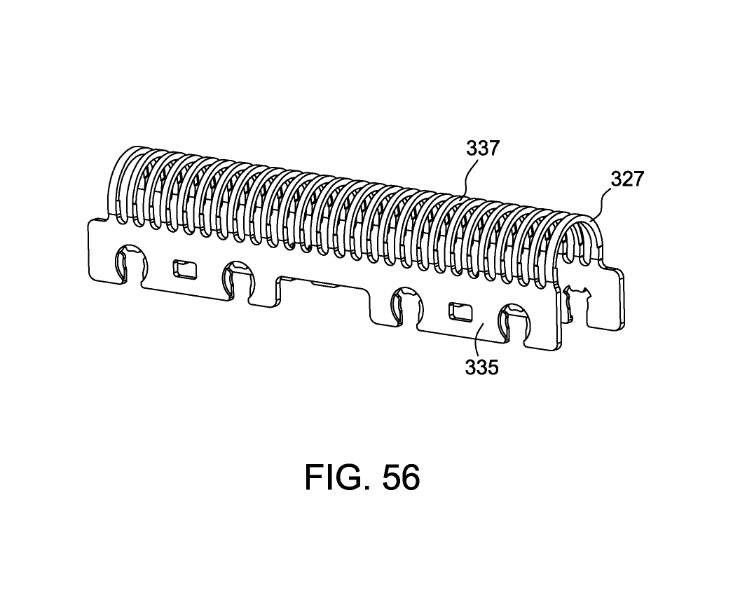

FIG. 56 is a perspective view of a movable blade of the movable blade assembly of FIG. 51;

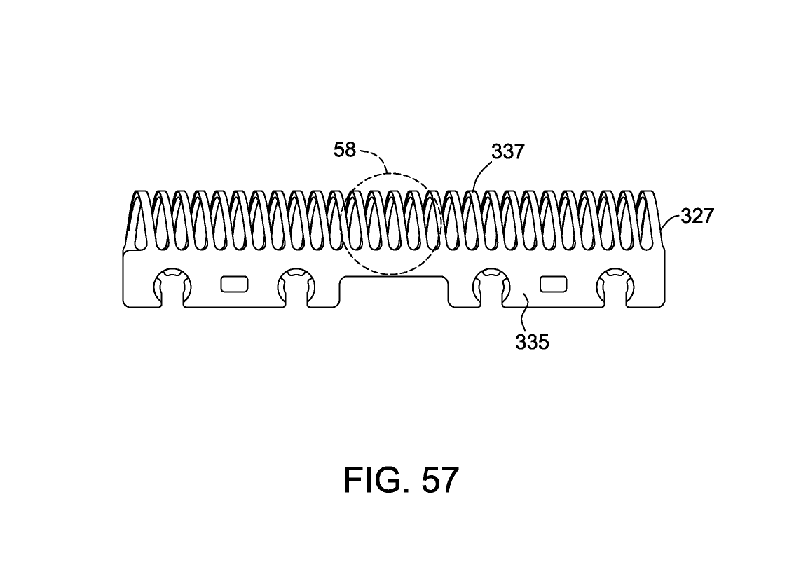

FIG. 57 is a side elevation of the movable blade of FIG. 56;

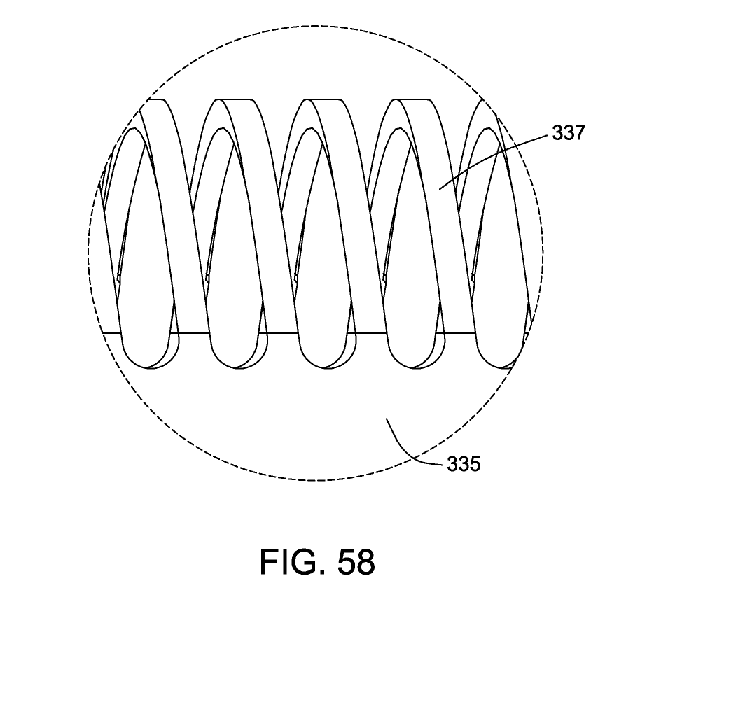

FIG. 58 is an enlarged portion of the side elevation of FIG. 57 taken within area 58;

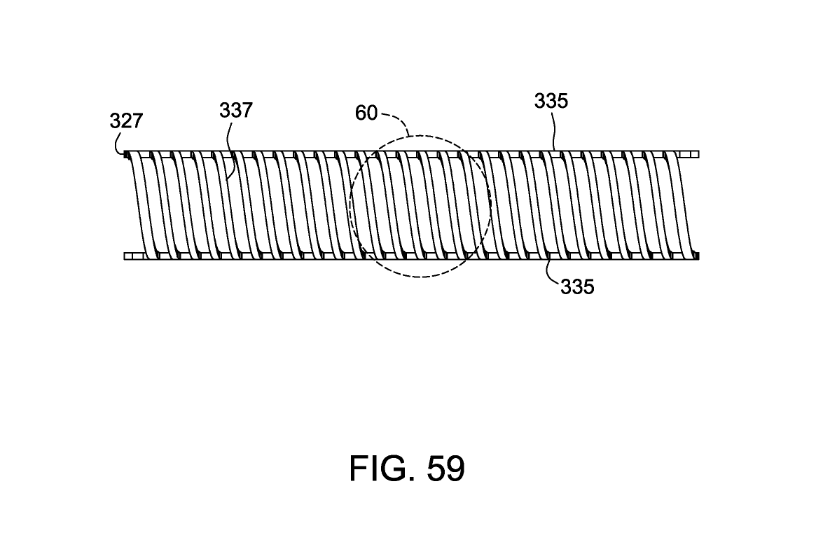

FIG. 59 is a top plan view of the movable blade of FIG. 56;

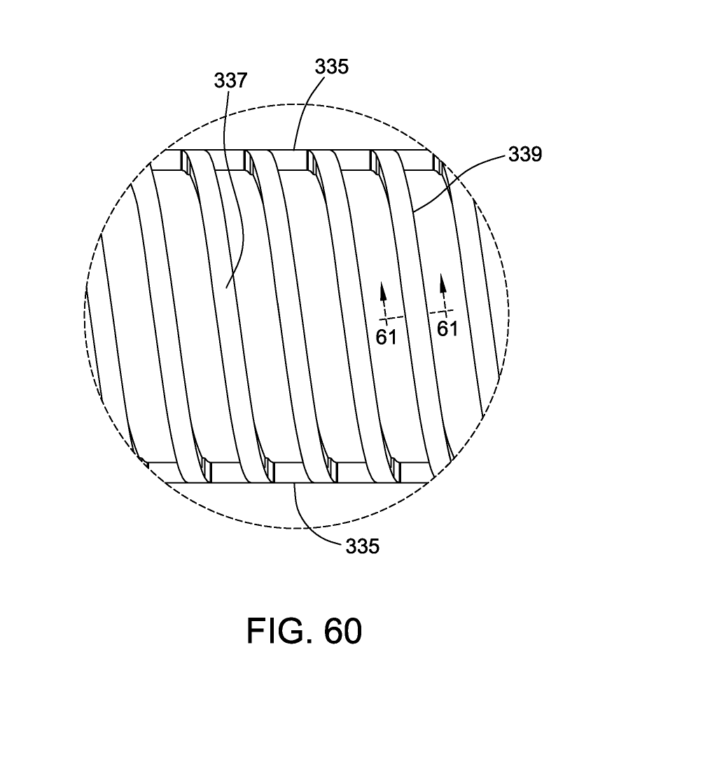

FIG. 60 is an enlarged portion of the top plan view of FIG. 59 taken within area 60;

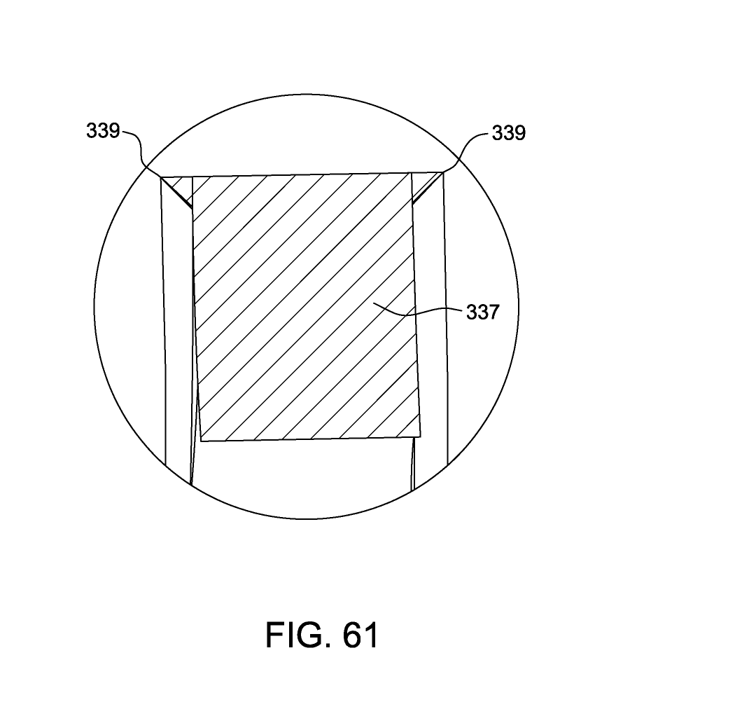

FIG. 61 is a cross-sectional view of the movable blade of FIG. 56 taken along plane 61-61 of FIG. 60;

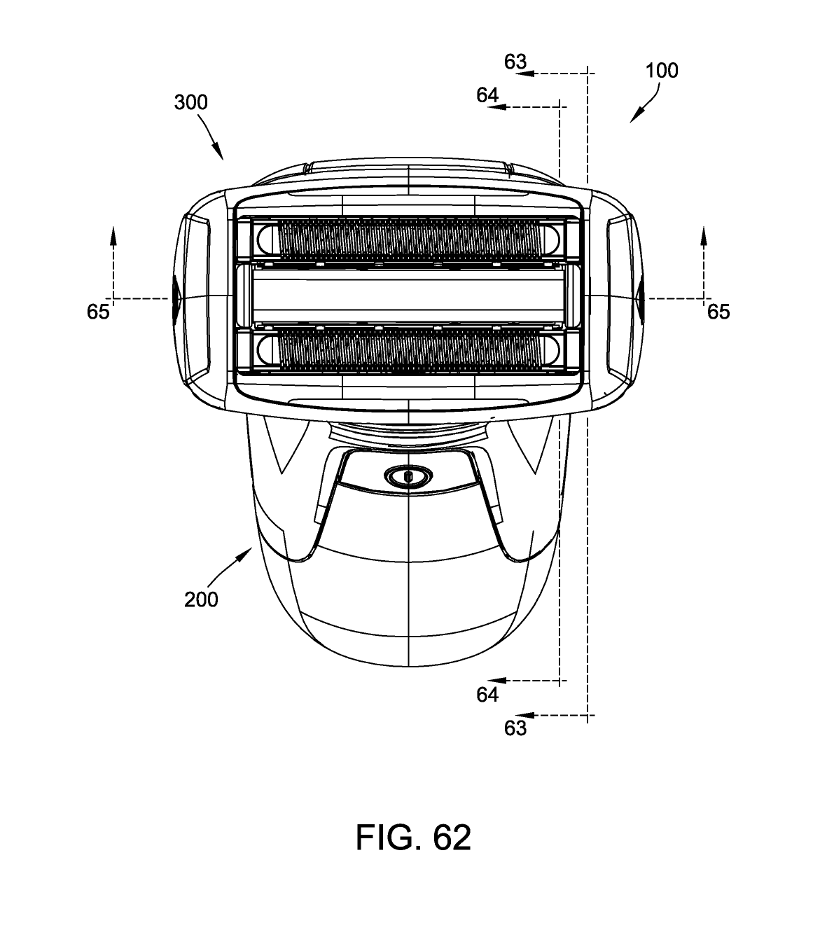

FIG. 62 is a top plan view of the shaver of FIG. 1;

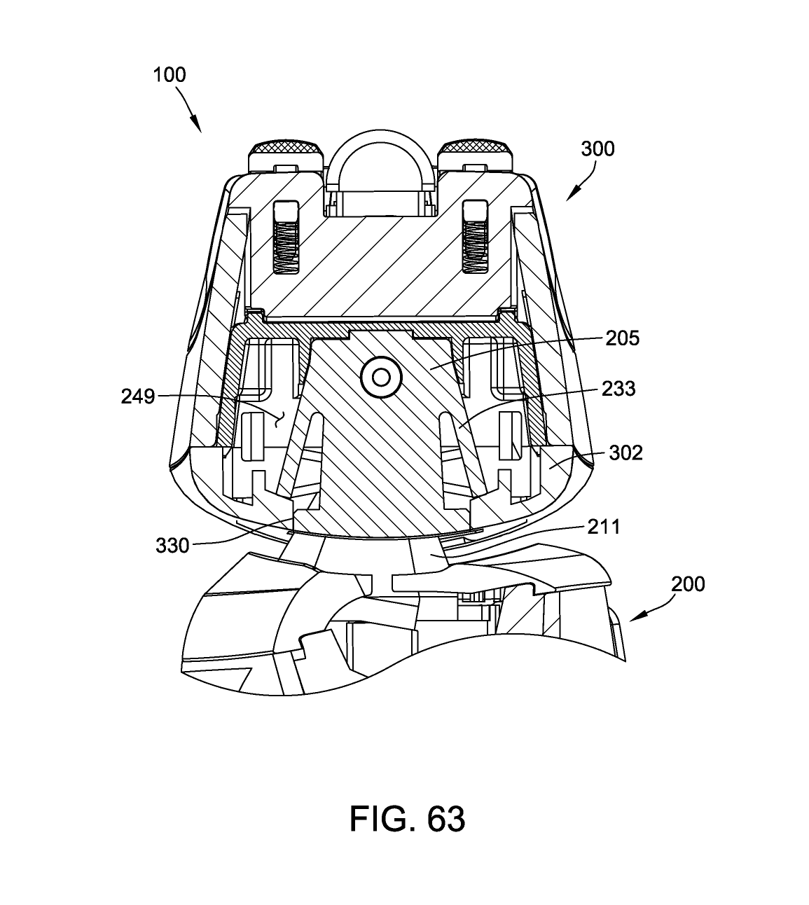

FIG. 63 is a cross-sectional view of the shaver of FIG. 1 taken along plane 63-63 of FIG. 62;

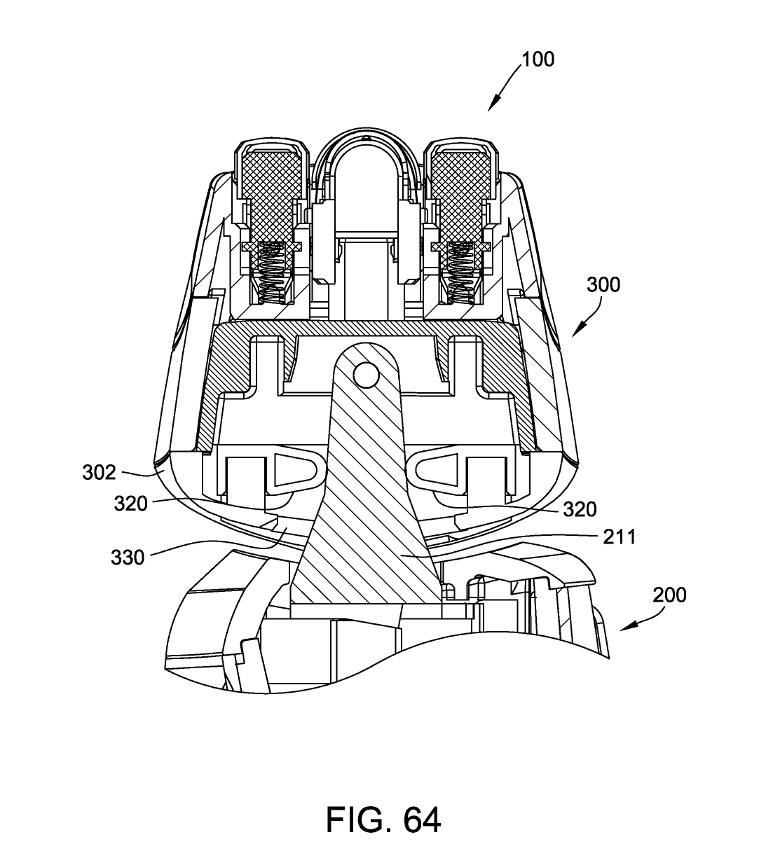

FIG. 64 is a cross-sectional view of the shaver of FIG. 1 taken along plane 64-64 of FIG. 62;

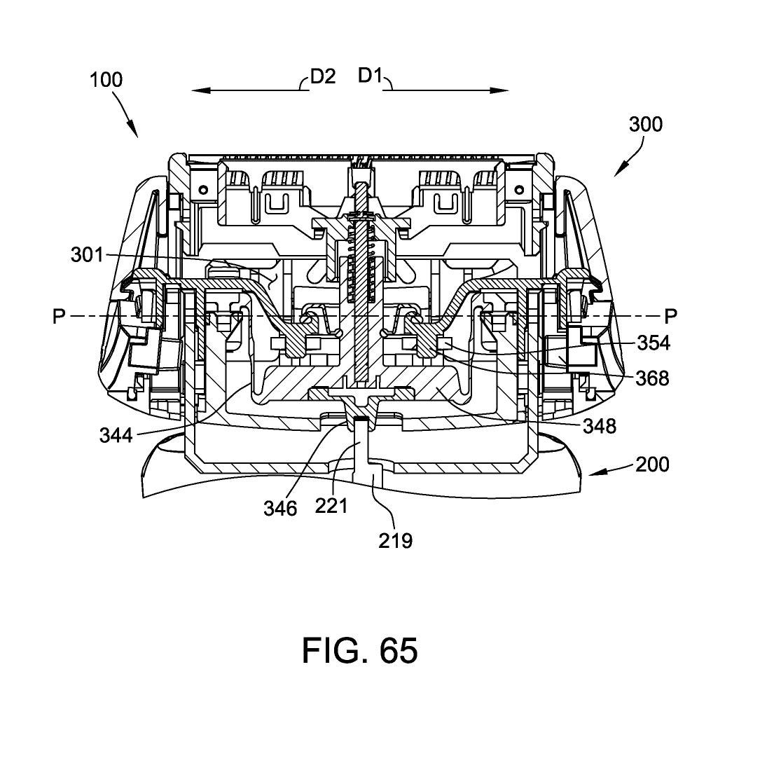

FIG. 65 is a cross-sectional view of the shaver of FIG. 1 taken along plane 65-65 of FIG. 62; and

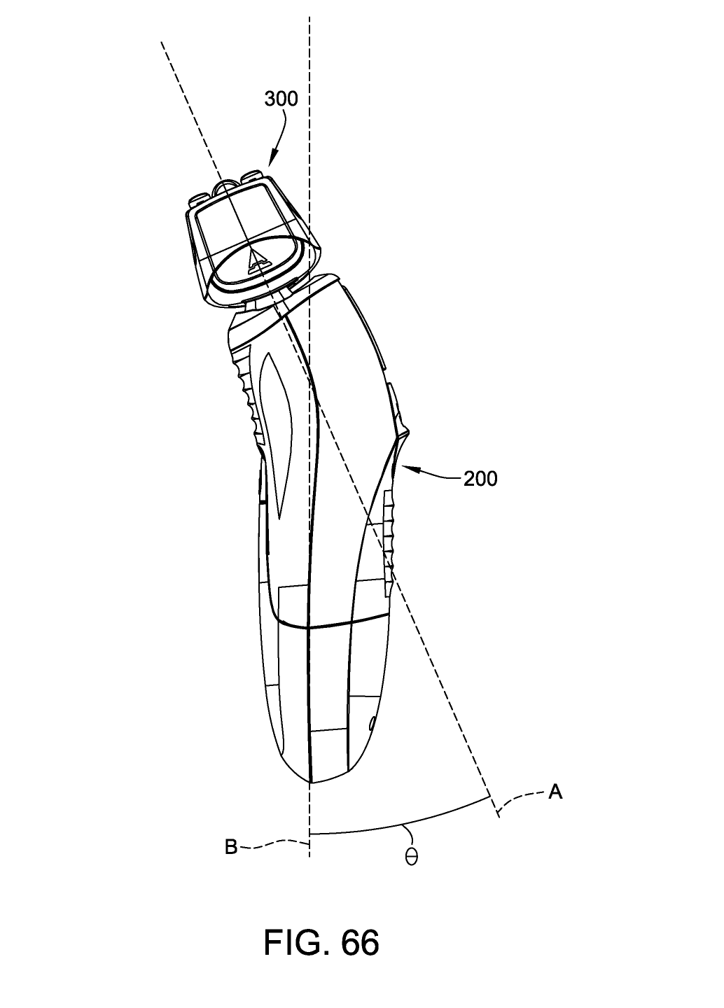

FIG. 66 is a side view of the shaver of FIG. 1; and

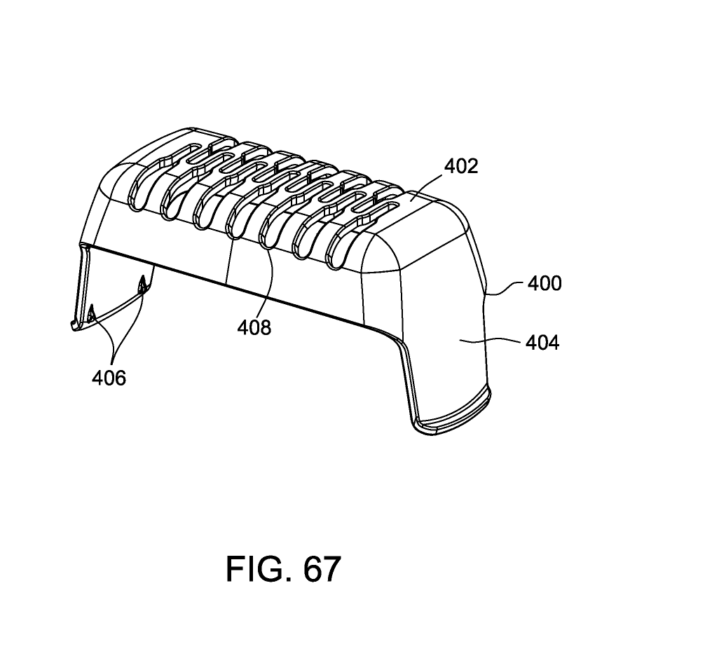

FIG. 67 is a perspective view of a guard for covering the head of FIG. 20.

Corresponding reference characters indicate corresponding parts throughout the several views of the drawings.

### DETAILED DESCRIPTION

Referring now to the drawings, and in particular to FIG. 1, an electric shaver according to one embodiment is indicated generally by the reference numeral 100 and is illustrated in the form of an oscillating shaver (commonly referred to as a “foil shaver”) used for shaving hair from one's skin. It is understood, however, that elements of the shaver 100 may also be used on other suitable hair grooming devices (e.g., a rotary shaver, an epilator, a clipper, etc.) without departing from the scope of this invention. The illustrated shaver 100 comprises a handle, generally indicated at 200, and a head, generally indicated at 300, pivotably connected to the handle 200.

As shown in FIG. 1 and referred to throughout the following description, the shaver 100 has a width dimension along an axis X-X, a height dimension along an axis Y-Y, and a depth dimension along an axis Z-Z. These axes share a center C. As used herein, the terms “inner,” “inward,” “outer,” “outward,” and any variations thereof are directional modifiers indicating a disposition relative to the center C along the axis X-X. The terms “top,” “upper,” “upward,” “above,” “bottom,” “lower,” “downward,” “beneath,” and any variations thereof are directional modifiers indicating a disposition relative to the center C along the axis Y-Y. The terms “front,” “forward,” “rear,” “back,” “backward,” and any variations thereof are directional modifiers indicating a disposition relative to the center C along the axis Z-Z.

Referring now to FIG. 2, the illustrated handle 200 has a housing that includes a core 202 and a shell 204 that encloses a mid-to-upper region of the core 202. The shell 204 has a plurality of housing segments, namely a two-piece front panel 206 and a back panel 208. The front panel 206 includes a base layer 210 and a grip layer 212. A trimmer 214 is mounted on the back panel 208. The grip layer 212 has a power button 216 and a display window 218, and the base layer 210 has a button aperture 220 and a display aperture 222. Notably, the back panel 208 is suitably configured to face the user's four fingers when the user grips the handle 200, and the front panel 206 is suitably configured to face away from the user's four fingers when the user grips the handle 200, such that the shaver 100 can be gripped and powered ON with one hand via thumb-activation of the power button 216.

As shown in FIGS. 3 and 4, the core 202 has a plurality of housing segments, namely a front half 224 and a back half 226 that are connected together to sealingly enclose a power supply (e.g., rechargeable batteries, which are not shown), a motor 228, and associated circuitry (not shown) in a watertight manner. The front half 224 of the core 202 has a button hole 230, and the back half 226 of the core 202 has a pair of charge pin holes 232. The charge pin holes 232 are disposed on a lower region 234 of the back half 226, and the lower region 234 is configured to be exposed exterior of the shell 204 when the shell 204 is coupled to the core 202 to enclose the mid-to-upper region of the core 202. Charge pins (not shown) thereby project from the core 202 via the charge pin holes 232 so as to extend rearward from the core 202. The charge pins are suitably connected to the power supply of the shaver 100 for charging the power supply when the shaver 100 is not in use.

In the illustrated embodiment, a gasket 238 is molded together with (i.e., is irremovably affixed to) the front half 224 of the core 202 using, for example, a multi-shot (e.g., a two-shot) molding process. Notably, the gasket 238 is compressible (e.g., is more compressible than the front half 224) and is configured to occupy gaps at the annular seam 240 between the front half 224 and the back half 226 when the front half 224 is attached to the back half 226. In this manner, the gasket 238 makes the core 202 watertight at the seam 240 when the front half 224 is attached to the back half 226 via latches 242. In other embodiments, the gasket 238 may be irremovably affixed to the front half 224 (and/or the back half 226) of the core 202 in any suitable manner (e.g., using an adhesive). However, in alternative embodiments, the gasket 238 may not be molded together with, or otherwise irremovably affixed to, the front half 224 or the back half 226 of the core 202 but, rather, may be formed separately from, and then removably seated on, the front half 224 or the back half 226 of the core 202.

The front half 224 of the core 202 also defines a motor sleeve 236 in which the motor 228 is seated. As shown in FIG. 5, the gasket 238 has an annular segment 244 and a crosswise segment 246 that are integrally formed together, the crosswise segment 246 defining a button seal 248 and a motor sleeve seal 250. The button seal 248 is sized for covering the button aperture 230 of the core 202, and the motor sleeve seal 250 is sized for disposition about a periphery of the motor sleeve 236. When the motor 228 is seated in the motor sleeve 236, the motor sleeve seal 250 occupies open space between the motor 228 and the front half 224 of the core 202. In this manner, because the gasket 238 is compressible, the motor sleeve seal 250 provides for watertight sealing of at least a portion of the motor sleeve 236 between the motor 228 and the front half 224 of the core 202, while also providing vibration dampening benefits associated with absorbing vibrations of the motor 228 during operation of the shaver 100. In alternative embodiments, the gasket 238 may be configured to provide for either a watertight sealing benefit or a vibration dampening benefit, without providing for both benefits (i.e., the term “gasket” as used herein is not limited to a member that provides for a fluid seal).

Referring again to FIG. 2, in the assembled configuration of the handle 200, the watertight core 202 is disposed within the shell 204 such that a display 252 mounted on the core 202 projects from the display aperture 222 of the base layer 210 so as to be visible to the user via the display window 218 of the grip layer 212. Moreover, the power button 216 of the grip layer 212 is aligned with the button aperture 220 of the base layer 210 forward of the button seal 248 such that the shaver 100 is operable by pushing the power button 216 backward to deflect the button seal 248 in order to transfer the force from the power button 216 to an electrical switch of the circuitry housed within the core 202. In this manner, the power button 216 may be used to actuate the motor 228, and the power button 216 may also be used to interact with a control unit (e.g., a microprocessor and associated memory) housed within the sealed core 202.

Notably, in some embodiments the power button 216 may be operable for locking/unlocking the shaver 100. For example, by pressing and holding the power button 216 for a predetermined time period (e.g., 5 seconds), the shaver 100 will enter a locked mode. In the locked mode, the power button 216 is inoperable for actuating the motor 228 until the shaver 100 is unlocked, which is accomplished by pressing and holding the power button 216 again for the same predetermined period of time (e.g., 5 seconds). As such, in the locked mode the shaver 100 would not become operable based solely on a short press of the power button 216 (i.e., a press lasting less than 5 seconds). In this manner, the shaver 100 is lockable when not in use, thereby inhibiting the shaver 100 from being inadvertently operated such as, for example, when the shaver 100 is stowed in luggage during travel.

With reference to FIGS. 6-11, the back panel 208 of the shell 204 has, on its front side, a set of hooks 254 for attaching the back panel 208 to the core 202 near the seam 240. The back panel 208 also has, on its back side, a trimmer seat 256 by which the pop-up trimmer 214 is mounted on the back panel 208. A fastener aperture 258 extends through the back panel 208 for fixing the back panel 208 to the core 202 via a fastener (e.g., a screw 241, shown in FIG. 2). To facilitate mounting the pop-up trimmer 214 on the back panel 208, the back panel 208 also has a pair of substantially parallel rails 260, as well as pivot pins 262 that extend inward from opposing sides 264 of the pop-up trimmer seat 256 toward one another. The back panel 208 further includes a drive aperture 266 through which a drive connection can be made between the pop-up trimmer 214 and the motor 228 via a suitable transmission operably connected to the motor 228 within the core 202, as set forth in more detail below. The back panel 208 also includes a pair of substantially parallel ribs 268 (FIG. 8), each including a lower tab 270 and an upper tab 272 for locking the trimmer 214 in either the stowed position or the activated position described below.

The pop-up trimmer 214 includes a slide 274 having, on its back side, an engagement surface 276. On its front side, the slide 274 has a pair of clasps 278 that face one another, as well as a pair of ribs 280 each having a tab 282. The engagement surface 276 is contoured to enable a user to operate the slide 274 with a single finger (e.g., the thumb). The slide 274 also includes a prop member (e.g., a fork 284) that facilitates propping up the trimmer 214 when the trimmer 214 is activated. The fork 284 has a pair of arms 286, each arm 286 having a stud 288 near its distal end 290 such that the studs 288 extend outward away from one another. The pop-up trimmer 214 also has a cover 292 with a pair of opposing pin slots 294 each sized to receive one of the pivot pins 262 of the trimmer seat 256, as well as a pair of opposed stud slots 296 each sized to receive one of the studs 288.

The cover 292 also has a pair of notches 298 for securing, within the cover 292, a plurality of cutting components of the trimmer 214, namely a tray 253, a rocker-type drive arm 255, a leaf spring 257, a blade mount 259, a movable blade 261, and a stationary blade 263. The stationary blade 263 is immovably mounted on the inside of the cover 292, and the movable blade 261 is positioned against the stationary blade 263 so as to be slidable in face-to-face contact with the stationary blade 263. The blade mount 259 supports the movable blade 261 with the drive arm 255 rockably mounted on the inside of the cover 292 such that a tip 265 of the drive arm 255 extends into a hub 267 of the blade mount 259. The leaf spring 257 is disposed beneath the drive arm 255 on the tray 253. When the tray 253 is attached to the cover 292 via wings 269 of the tray 253 being inserted into the notches 298 of the cover 292, the leaf spring 257 straddles the drive arm 255 to urge the blade mount 259 and, therefore, the movable blade 261 toward the stationary blade 263.

With the stationary blade 263, the movable blade 261, the blade mount 259, the drive arm 255, the leaf spring 257, and the tray 253 mounted to the cover 292, the cover 292 is then attached to the slide 274 by inserting the studs 288 of the slide 274 into the stud slots 296 of the cover 292, thereby forming the fully assembled pop-up trimmer 214. The fully assembled pop-up trimmer 214 is then attached to the back panel 208 in the trimmer seat 256 by engaging the clasps 278 of the slide 274 on the rails 260 of the back panel 208. The ribs 280 of the slide 274 are thereby positioned adjacent the ribs 268 of the back panel 208, with the tabs 270, 272 of each rib 268 facing the tab 282 of the adjacent rib 280 such that the tabs 282 interfere with, and therefore must traverse, the corresponding tabs 270, 272 when the slide 274 is displaced upward and downward. The cover 292 is also connected to the back panel 208 such that the pivot pins 262 of the back panel 208 are inserted into the pin slots 294 of the cover 292.

In this manner, the slide 274 is configured for displacement upward and downward within the trimmer seat 256 such that the clasps 278 ride upward and downward along the rails 260. As the slide 274 moves upward, the fork 284 pushes the cover 292, and the components attached thereto, to an upright (or rearward pointing) position. As the slide 274 moves downward, the fork 284 pulls the cover 292, and the components attached thereto, to a stowed (or downward pointing) position, which is shown in FIG. 6. When the cover 292 is in the upright position, the drive arm 255 engages a drive coupling (not shown) within the shell 204 to drive the movable blade 261 back-and-forth relative to the stationary blade 263 upon actuation of the motor 228. When the cover 292 is in the stowed position, however, the drive arm 255 is disengaged from the drive coupling within the shell 204 such that the movable blade 261 is not driven back-and-forth upon actuation of the motor 228.

In the stowed position, the tabs 282 are positioned below their corresponding lower tabs 270. To move the pop-up trimmer 214 from the stowed position to the upright position, the tabs 282 must first traverse their corresponding lower tabs 270, and must then traverse their corresponding upper tabs 272. When the tabs 282 are above their corresponding upper tabs 272, the pop-up trimmer 214 is said to be locked in the upright position. As such, to move the trimmer 214 from the upright position back to the stowed position, the tabs 282 must first traverse their corresponding upper tabs 272 and must then traverse their corresponding lower tabs 270. The tabs 282 will again be below their corresponding lower tabs 270, such that the trimmer 214 is said to again be locked in the stowed position. Of course, sufficient upward or downward force imparted to the slide 274 by the user will cause the tabs 282 to traverse the tabs 270, 272 in such a manner, allowing the user to toggle the trimmer 214 between the stowed and upright locked positions as desired.

Notably, when describing the blades of a cooperating blade arrangement herein, the terms “movable” and “stationary” are used merely for reference purposes. As such, the various arrangements of cooperating “movable” and “stationary” blades described herein are not intended to be limiting but, rather, are intended to provide examples of some of the many cooperating blade arrangements that are contemplated. In other embodiments, either (or both) of the trimmer/cutter blades in any given cooperating blade arrangement may move relative to the other without departing from the scope of this invention.

Referring now to FIGS. 12-16, the movable blade 261 has a plurality of spaced-apart teeth 271 each having a contacting surface 273 that slides against corresponding teeth 275 (shown in FIG. 10) of the stationary blade 263. Each tooth 271 of the movable blade 261 has a generally frusto-conical planform shape (shown in FIGS. 13 and 14), with a substantially crescent shaped relief 277 formed between adjacent teeth 271. Moreover, as shown in FIGS. 15 and 16, each tooth 271 of the movable blade 261 has a substantially Y-shaped cross-sectional profile that widens continuously from the tip 279 of the tooth 271 to the base 281 of the tooth 271. With such a configuration, the cutting performance of the movable blade 261 is improved.

With reference to FIGS. 17-19, to facilitate attaching the head 300 to the handle 200, the handle 200 further includes a cap 201, a yoke 203, a pair of clips 205, and a pair of bearing assemblies 207. The yoke 203 has a base plate 209 suitably fastened to the core 202, and a pair of arms 211 projecting upward from the base plate 209. Each arm 211 has a spindle slot 213 defined near its distal end 215. Notably, the base plate 209 defines a central drive passage 217 that permits a drive shaft 219 of the motor 228 to project from the core 202 through the yoke 203 to dispose an eccentric drive pin 221 of the drive shaft 219 between the arms 211 of the yoke 203.

The cap 201 defines a pair of opposing slits 223 and a central drive passage 225. When the cap 201 is fastened to the core 202 via a plurality of fasteners (not shown) inserted into corresponding fastener apertures 227 of the cap 201, the arms 211 of the yoke 203 project from the cap 201 via the slits 223, and the drive shaft 219 of the motor 228 projects from the cap 201 by virtue of the drive passage 225 of the cap 201 being aligned with the drive passage 217 of the yoke 203. In this manner, the arms 211 of the yoke 203, and the drive shaft 219 of the motor 228 (e.g., the eccentric drive pin 221), are situated above the cap 201 for engaging the head 300 of the shaver 100, as set forth in more detail below.

Each clip 205 has a body 229 that defines a spindle slot 231 and a pair of opposing, resilient wings 233 extending downward from the body 229. Each clip 205 is attached to a corresponding one of the arms 211 of the yoke 203 via one of the bearing assemblies 207, and each bearing assembly 207 includes a spindle 235 and an O-ring 237. The spindle 235 is inserted, at one end thereof, into the spindle slot 213 of the corresponding arm 211, and is inserted at the other end thereof into the spindle slot 231 of the corresponding clip 205. The O-ring 237 circumscribes the spindle 235 within the spindle slot 231 of the clip 205. In this manner, the clips 205 are irremovable from, and are pivotable forward and backward relative to, the arms 211 of the yoke 203 via the spindles 235. The O-rings 237 facilitate a smoother and more controlled pivoting motion.

With reference to FIGS. 20 and 21, the head 300 includes a base 302, a housing 304, a chassis 306, and a plurality of cutter assemblies, namely a first long hair cutter assembly 308, a second long hair cutter assembly 310, and a short hair cutter assembly 312 situated between the long hair cutter assemblies 308, 310. Optionally, in other embodiments, the head 300 may have any suitable number of cutter assemblies arranged in any suitable manner that facilitates enabling the shaver 100 to function as described herein.

As shown in FIGS. 22 and 23, the base 302 has a bottom frame 314 and a top frame 316 mounted on the bottom frame 314. Also mounted on the bottom frame 314 beneath the top frame 316 is a pair of opposed detent assemblies 318, a plurality of biasing members 320, and an oscillator assembly 344. Referring now to FIGS. 24-29, the bottom frame 314 has a pair of opposing support walls 322, a pair of ledges 324, a plurality of posts 326, and a pair of grooves 328. The bottom frame 314 also includes a plurality of slots, namely a pair of yoke slots 330 and a drive slot 332 disposed between the yoke slots 330. Suitably, in other embodiments, the base 302 may have any suitable number of slots arranged in any suitable manner.

Each detent assembly 318 includes a spring 334 and a button 336. The button 336 has a top catch 338, a pair of side catches 340, and a pivot member 342. Each spring 334 is seated against its corresponding support wall 322, and each button 336 is attached to its corresponding support wall 322 such that the side catches 340 grip onto the sides of the support wall 322 with the spring 334 disposed between the button 336 and the support wall 322, and with the pivot member 342 disposed within the groove 328. In this manner, when a user presses the button 336, the button 336 pivots inward about the pivot member 342 to compress the spring 334. When the user releases the button 336, the spring 334 is permitted to decompress, thereby pivoting the button 336 outward about the pivot member 342. Both detent assemblies 318 function in the same manner.

Moreover, each biasing member 320 is in the form of a resilient (e.g., rubber) finger, and each biasing member 320 is seated on one of the posts 326. As such, the biasing members 320 are arranged in pairs, with one biasing member 320 of each pair being situated at an end of one of the yoke slots 330. However, in other embodiments, the head 300 may have any suitable number of biasing members 320 arranged in any suitable manner that facilitates enabling the biasing member(s) 320 to function as described herein.

Referring now to FIGS. 23, 30, and 31, the oscillator assembly 344 includes a generally arcuate coupling 346, a first oscillator 348, a second oscillator 350, a pair of joints 352, and a pair of links 354. The oscillators 348, 350 are arranged side-by-side and are coupled together atop the ledges 324 via the joints 352 so as to be suspended above the drive slot 332 of the bottom frame 314. Moreover, the oscillators 348, 350 are operably coupled together by the links 354, and the coupling 346 is attached to the bottom of the first oscillator 348. In this manner, as set forth in more detail below, the oscillators 348, 350 are configured to translate substantially along the X-X axis in antiphase (i.e., when the first oscillator 348 moves in a first direction D1 as illustrated in FIG. 31, the second oscillator 350 is driven in the second direction D2).

Notably, the first oscillator 348 has a first drive post 356 and a middle drive post 358 projecting upward therefrom. The first drive post 356 is configured for driving the first long hair cutter assembly 308, and the middle drive post 358 is configured for driving the short hair cutter assembly 312. Similarly, the second oscillator 350 has a second drive post 360 projecting upward therefrom, and the second drive post 360 is configured for driving the second long hair cutter assembly 310. Notably, a biasing member 362 is seated on the middle drive post 358, and a joint 364 is seated on the middle drive post 358 above the biasing member 362 such that the joint 364 is floatable on the middle drive post 358 via the biasing member 362.

As shown in FIGS. 22, 23, 32, and 33, the top frame 316 is configured to be coupled to the bottom frame 314 atop the oscillators 348, 350 such that the drive posts 356, 358, 360 project through a drive window 366 of the top frame 316. Additionally, the top frame 316 has a pair of bosses 368 projecting downward from its underside such that, when the top frame 316 is mounted on the bottom frame 314, each of the links 354 of the oscillator assembly 344 is rotatably fitted on one of the bosses 368 such that the links 354 can pivot about the bosses to drive the oscillators 348, 350 in antiphase. Moreover, a flexible gasket 370 is attached to the top frame 316 to cover otherwise open space between the top frame 316 and the drive posts 356, 358, 360, thereby permitting the drive posts 356, 358, 360 to oscillate within the drive window 366 while inhibiting hair and other shaving debris from entering the drive window 366.

During assembly of the shaver 100 as best illustrated in FIG. 63, the head 300 is attached to the handle 200 by inserting the arms 211 of the yoke 203 upward into the yoke slots 330 of the base 302. In this manner, the clips 205 are also inserted into the yoke slots 330. As the clips 205 enter the yoke slots 330, however, the wings 233 of each clip 205 must flex toward one another in order for the clip 205 to fit within the yoke slot 330. When each clip 205 has been inserted a sufficient distance into its associated yoke slot 330, the clip 205 enters space 249 inward of the support walls 322, and the wings 233 are permitted to relax away from one another. Once the wings 233 relax, the clips 205 cannot be removed from the base 302 via the yoke slots 330 by nature of each pair of relaxed wings 233 having a span larger than their associated yoke slot 330.

As such, simply by inserting the arms 211 of the yoke 203 into the yoke slots 330, the clips 205 can be said to self-attach (or automatically attach) to the base 302 of the head 300 (i.e., no action other than insertion of the arms 211 into the yoke slots 330 needs to be taken to pivotably attach the base 302 to the handle 200 during assembly of the shaver 100). In this manner, the base 302 of the head 300 is retained on the handle 200 so as to be pivotable relative to the arms 211 of the yoke 203 along with the clips 205.

Notably, in an alternative embodiment, the clips 205 may be components of the head 300 configured for automatic attachment to the handle 200, rather than being components of the handle 200 configured for automatic attachment to the head 300 as set forth above. In such an alternative embodiment, when the arms 211 of the yoke 203 are inserted into the yoke slots 330, each of the clips 205 (as part of the head 300) would automatically attach to one of the arms 211 or a suitable structure fixed to one of the arms 211. Thus, self-attachment of the head 300 to the handle 200 via the clips 205 is contemplated no matter whether the clips 205 are part of the head 300 or part of the handle 200 prior to attachment of the head 300 to the handle 200. In that regard, each of the clips 205 may be configured for self-attachment in any suitable manner, and the clips 205 are not limited to the winged configuration shown in FIG. 19.

As shown in FIG. 64, upon insertion of the arms 211 into the yoke slots 330, the arms 211 are disposed between the biasing members 320. In this manner, when forces are imparted to the head 300 by a user during a shaving operation, the base 302 may pivot relative to the arms 211, causing the arms 211 to compress the biasing members 320 that are disposed opposite the pivoting direction of the base 302 (i.e., if the base 302 pivots forward, then the rearward biasing members 320 compress; and if the base 302 pivots rearward, then the forward biasing members 320 compress). When the pivoting forces are subsequently relieved, the compressed biasing members 320 are permitted to decompress, thereby returning the base 302 back to its non-pivoted position (i.e., the upwardly-directed, or centered, position shown in FIG. 64). As such, the interaction between the arms 211 of the yoke 203 and the biasing members 320 of the base 302 provides a self-centering mechanism for the head 300.

As shown in FIG. 65, when the head 300 is attached to the handle 200 in the manner set forth above, the eccentric drive pin 221 of the drive shaft 219 is received in the coupling 346 of the oscillator assembly 344. Thus, upon actuation of the motor 228, the eccentric drive pin 221 rotates, which causes the coupling 346 to translate substantially along the X-X axis. Because the coupling 346 is attached to only the first oscillator 348, the first oscillator 348 is initially caused to translate along the X-X axis in direction D1 along with the coupling 346. However, by nature of the links 354 being rotatably fitted on the bosses 368, translation of the first oscillator 348 in the first direction D1 causes the second oscillator 350 to be translated in the second direction D2. In this manner, the first and second oscillators 348, 350 continue to switch between moving in the first direction D1 and the second direction D2 in antiphase with one another. Moreover, the configuration set forth above places the pivot axis P of the head 300 (also shown in FIG. 18) substantially (i.e., almost entirely) beneath a hair pocket 301 of the head 300.

Referring back to FIG. 34, the housing 304 has a recess 372 defined on the interior of each of its sidewalls 374, and each recess 372 is sized to receive the top catch 338 of one of the buttons 336 to removably retain the housing 304 on the base 302 of the head 300. The housing 304 also includes a pair of recesses 376 on each of its front and back walls 378, 380 to facilitate retaining the chassis 306 on the housing 304, as set forth in more detail below. Suitably, in other embodiments, the housing 304 may not be a separate component from the chassis 306 (i.e., the housing 304 and the chassis 306 may be formed integrally together). Alternatively, the head 300 may have any suitable support structures that facilitate retaining the cutter assemblies 308, 310, 312 as described herein.

With reference now to FIGS. 35-37, the chassis 306 defines three side-by-side channels in which the cutter assemblies 308, 310, 312 are floatably retained. Specifically, the chassis 306 has a first channel 382 for retaining the first long hair cutter assembly 308, a second channel 384 for retaining the second long hair cutter assembly 310, and a middle channel 386 disposed between the first channel 382 and the second channel 384 for retaining the short hair cutter assembly 312. Moreover, the chassis 306 also includes a pair of hooks 388 on each of its front wall 390 and back wall 392, and each of the hooks 388 is received within one of the recesses 376 of the housing 304 to facilitate retaining the chassis 306 on the housing 304. Additionally, the chassis 306 further includes a spring seat 394 defined at the opposing ends 396 of each channel 382, 384 for supporting a pair of opposed floating springs 398 that enable the cutter assemblies 308, 310 to float within their respective channels 382, 384.

When the housing 304, chassis 306, and cutter assemblies 308, 310, 312 are coupled to the base 302 in this manner, the hair pocket 301 (FIG. 65) is formed therebetween for collecting hair and other debris that results from a shaving operation. As set forth above, the chassis 306 (and, therefore, the cutter assemblies 308, 310, 312) are removable from the base 302 together with the housing 304 by pressing the buttons 336 inward to withdraw the top catches 338 from their associated recesses 372. It is, therefore, desirable for the user to periodically remove the housing 304, chassis 306, and cutter assemblies 308, 310, 312 conjointly from the base 302 in order to clean hair and other debris from the hair pocket 301.

Referring now to FIGS. 38-48, the first long hair cutter assembly 308 will be described. Notably, the second long hair cutter assembly 310 is structurally configured in the same manner as the first long hair cutter assembly 308. As such, the second long hair cutter assembly 310 functions in the same manner as the first long hair cutter assembly 308. In some suitable embodiments, however, the long hair cutter assemblies 308, 310 may be configured differently from one another. Alternatively, in other embodiments, the head 300 may have any suitable number of short hair cutter assemblies and/or long hair cutter assemblies arranged in any suitable manner.

As shown in FIGS. 38 and 39, the first long hair cutter assembly 308 includes a frame 303, a carrier 305, a movable blade 307, and a stationary blade 309. The frame 303 supports the stationary blade 309 and the carrier 305 (via the illustrated pair of springs), and the carrier 305 in turn supports the movable blade 307 in shearing contact with the stationary blade 309. The carrier 305 is configured for coupling to the first drive post 356 so as to move in oscillation together with the first drive post 356 in directions D1 and D2 when the motor 228 is actuated.

With particular reference to FIGS. 40-43, the stationary blade 309 has a pair of sidewalls 311 and a plurality of cutting members 313 extending between the sidewalls 311 such that the stationary blade 309 has a generally U-shaped cross-sectional profile (FIG. 42). Notably, each of the cutting members 313 has a central concavity 315 between a pair of surfaces 317 that have a substantially linear cross-sectional profile and are sloped relative to the sidewalls 311. In this manner, each cutting member 313 has a thickness that decreases and subsequently increases as the cutting member 313 extends from one sidewall 311 to the other. The sloped surfaces 317 facilitate providing for a more comfortable shaving experience, as they are likely to be the leading blade surfaces to interact with the skin during a shaving stroke.

Moreover, from the viewpoint of FIG. 43, the cutting members 313 of the stationary blade 309 are substantially linear in their extension from one sidewall 311 to the other. Notably, however, each substantially linearly extending cutting member 313 is angled obliquely relative to the sidewalls 311. In other embodiments, the stationary blade 309 may have any suitable cross-sectional shape, and the cutting members 313 may extend along any suitable path from one sidewall 311 to the other, so as to have any suitable orientation relative to the respective sidewalls 311.

Referring now to FIGS. 44-46, the movable blade 307 is attached to the carrier 305 so as to be movable together with the carrier 305. Like the stationary blade 309, the movable blade 307 is generally U-shaped and has a pair of sidewalls 319, along with a plurality of cutting members 321 extending between the sidewalls 319. Moreover, like the stationary blade 309, the cutting members 321 of the movable blade 307 extend substantially linearly from one sidewall 319 to the other, and are oriented obliquely relative to the respective sidewalls 319.

As shown in FIGS. 47 and 48, when the first long hair cutter assembly 308 is assembled, it is apparent that, relative to an axis A normal to the sidewalls 311 of the stationary blade 309, the cutting members 321 of the movable blade 307 are oriented obliquely at a positive angle α, and the cutting members 313 of the stationary blade 309 are oriented obliquely at a negative angle β. As such, the cutting members 321 of the movable blade 307 are skewed relative to the cutting members 313 of the stationary blade 309, such that the cutting members 313, 321 appear crisscrossed (e.g., the cutting members 313, 321 collectively form a plurality of X-type planform shapes when the first long hair cutter assembly 308 is seen from the viewpoint of FIG. 48).

Referring now to FIGS. 49 and 50, the short hair cutter assembly 312 includes a stationary blade 323 and a frame 325 to which the stationary blade 323 is attached. The short hair cutter assembly 312 further includes a movable blade 327 and a carrier 329 to which the movable blade 327 is attached for support. While not shown in the Figures, the illustrated stationary blade 323 is a “foil-type” blade provided with a plurality of generally circular apertures spaced in any suitable manner that allows hair to extend through the stationary blade 323 for cutting by the movable blade 327 during a shaving operation.

As shown in FIGS. 51-55, as well as referring back to FIG. 23, the carrier 329 has a plurality of clips 331 and a central sleeve 333. Using the clips 331, the carrier 329 detachably grips the joint 364 of the oscillator assembly 344 to retain the carrier 329 on the joint 364 with the middle drive post 358 received in the sleeve 333. By virtue of this connection to the middle drive post 358, the carrier 329 (and, therefore, the movable blade 327 attached to the carrier 329) can oscillate relative to the stationary blade 323 in directions D1 and D2 when the motor 228 is actuated. Moreover, the biasing member 362 acts to urge the movable blade 327 upward into shearing, face-to-face contact with the stationary blade 323. In this manner, when the carrier 329 is pushed downward on the middle drive post 358 during shaving, the biasing member 362 compresses, and the sleeve 333 of the carrier 329 slides down the middle drive post 358, so as to enable floating of the carrier 329 on the middle drive post 358.

With reference now to FIGS. 56-61, the movable blade 327 has a pair of sidewalls 335 and a plurality of cutting members 337 extending between the sidewalls 335 such that the movable blade 327 is substantially U-shaped. Notably, each of the cutting members 337 appears to have a serpentine (or generally S-shaped) extension from one sidewall 335 to the other when the movable blade 327 is seen from the viewpoint of FIG. 60. Moreover, each of the cutting members 337 has an opposed pair of acute cutting edges 339 extending continuously along substantially the entire length of the cutting member 337, as shown in FIG. 61.

As shown in FIG. 66, the shaver 100 is ergonomically optimized such that the head 300 is oriented with its longitudinal axis A at an angle θ relative to the longitudinal axis B of the handle 200. In this manner, the shaver 100 is configured to make the overall shaving experience more comfortable for the user by enabling the user to better maintain the head 300 in contact with the skin throughout the shaving operation. In the illustrated embodiment, the angle θ is about 19 degrees. In another embodiment, the angle θ may be between 17 degrees and 21 degrees. Alternatively, the head 300 may be oriented at any suitable angle relative to the handle 200 in other embodiments.

As shown in FIG. 67, the shaver 100 is also provided with a guard 400 for the head 300 when the shaver 100 is not in use. The guard 400 has a cover segment 402 and a pair of legs 404 extending downward from the cover segment 402. Each leg 404 has a pair of protrusions 406 for attaching the guard 400 to the head 300 below the buttons 336, and the cover segment 402 is sized to cover the cutter assemblies 308, 310, 312 when the guard 400 is attached to the head 300. Moreover, the cover segment 402 has a plurality of slits 408 (or openings) for providing ambient airflow to the cutter assemblies 308, 310, 312 when the guard 400 is attached to the head 300, thereby better enabling the cutter assemblies 308, 310, 312 (and the hair pocket 301) to dry in the event that they are wet after a shaving operation.

When introducing elements of the present invention or the preferred embodiment(s) thereof, the articles “a”, “an”, “the”, and “said” are intended to mean that there are one or more of the elements. The terms “comprising,” “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. An electric shaver comprising:
a handle; and
a head mounted on the handle, wherein the head comprises at least three cutter assemblies arranged in a forward-rearward direction,
wherein the cutter assemblies comprise a forwardmost cutter assembly and a rearwardmost cutter assembly that are long hair cutter assemblies, each of the long hair cutter assemblies comprising a substantially U-shaped upper blade and a lower blade in shearing contact with the upper blade, and
wherein the cutter assemblies further comprise a short hair cutter assembly disposed between the long hair cutter assemblies.

2. The electric shaver set forth in claim 1 wherein the head comprises only three cutter assemblies.

3. The electric shaver set forth in claim 1 wherein the upper blade has a pair of sidewalls and a plurality of cutting members extending between the sidewalls, the cutting members oriented obliquely relative to the sidewalls when the upper blade is viewed from a top plan viewpoint.

4. The electric shaver set forth in claim 3 wherein each of the cutting members extends substantially linearly between the sidewalls when the upper blade is viewed from the top plan viewpoint.

5. The electric shaver set forth in claim 3 wherein the lower blade is substantially U-shaped and is disposed within the upper blade, the lower blade comprising a pair of sidewalls and a plurality of cutting members extending therebetween such that the cutting members of the lower blade are skewed relative to the cutting members of the upper blade when the long hair cutter assembly is viewed from the top plan viewpoint.

6. The electric shaver set forth in claim 5 wherein the cutting members of the lower blade are oriented obliquely relative to the sidewalls of the lower blade when the lower blade is viewed from the top plan viewpoint.

7. The electric shaver set forth in claim 1 wherein the upper blade has a pair of sidewalls and a plurality of cutting members extending between the sidewalls, each of the cutting members including a leading blade surface with a cross-sectional profile that is substantially linear and is sloped relative to one of the sidewalls.

8. The electric shaver set forth in claim 1 wherein the upper blade has a pair of sidewalls and a plurality of cutting members extending between the sidewalls, each of the cutting members including a first leading blade surface with a cross-sectional profile that is substantially linear and is sloped relative to a first one of the sidewalls, and an opposed second leading blade surface with a cross-sectional profile that is substantially linear and is sloped relative to a second one of the sidewalls.

9. The electric shaver set forth in claim 1 wherein the short hair cutter assembly has a foil-type upper blade.

10. An upper blade for an electric shaver, the upper blade comprising a pair of sidewalls and a plurality of cutting members extending between the sidewalls such that the upper blade is substantially U-shaped, wherein the cutting members are oriented obliquely relative to the sidewalls when the upper blade is viewed from a top plan viewpoint.

11. The upper blade set forth in claim 10 wherein each of the cutting members extends substantially linearly between the sidewalls when the upper blade is viewed from the top plan viewpoint.

12. The upper blade set forth in claim 10 wherein each of the cutting members includes a leading blade surface with a cross-sectional profile that is substantially linear and is sloped relative to one of the sidewalls.

13. The upper blade set forth in claim 10 wherein each of the cutting members has a thickness that decreases and subsequently increases as the cutting member extends from one sidewall to the other sidewall.

14. A cutter assembly comprising a substantially U-shaped lower blade disposed within the upper blade of claim 10 such that the lower blade and the upper blade are in shearing face-to-face contact with one another, wherein the lower blade comprises a pair of sidewalls and a plurality of cutting members extending therebetween such that the cutting members of the lower blade are skewed relative to the cutting members of the upper blade when the cutter assembly is viewed from the top plan viewpoint.

15. The cutter assembly set forth in claim 14 wherein the cutting members of the lower blade are oriented obliquely relative to the sidewalls of the lower blade when the lower blade is viewed from the top plan viewpoint.

16. The cutter assembly set forth in claim 14 wherein the cutting members of the lower blade and the cutting members of the upper blade appear crisscrossed when the cutter assembly is viewed from the top plan viewpoint.

17. A lower blade for an electric shaver, the lower blade comprising a pair of sidewalls and a plurality of cutting members extending between the sidewalls such that the lower blade is substantially U-shaped, wherein the cutting members are oriented obliquely relative to the sidewalls when the lower blade is viewed from a top plan viewpoint.

18. The lower blade set forth in claim 17 wherein each of the cutting members extends substantially linearly between the sidewalls when the lower blade is viewed from the top plan viewpoint.

19. The lower blade set forth in claim 17 wherein each of the cutting members has a serpentine extension between the sidewalls when the lower blade is viewed from the top plan viewpoint.

20. A cutter assembly comprising a carrier to which the lower blade of claim 17 is attached, wherein the carrier has a sleeve for slidably receiving a drive post inside the lower blade.
